(19) United States
(12) Patent Application Publication
(10) Pub. No.: US 2016/0085517 A1
(43) Pub. Date: Mar. 24, 2016

(54) PROGRAM INFORMATION GENERATING SYSTEM, PROGRAM INFORMATION GENERATING METHOD, AND COMPUTER PROGRAM PRODUCT

(71) Applicant: Kabushiki Kaisha Toshiba, Minato-ku (JP)

(72) Inventors: Yohei HASEGAWA, Kawasaki (JP); Akira KURODA, Yokohama (JP); Hidenori MATSUZAKI, Fuchu (JP); Nobuaki TOJO, Tachikawa (JP); Mayuko KOEZUKA, Ota (JP)

(73) Assignee: Kabushiki Kaisha Toshiba, Minato-ku (JP)

(21) Appl. No.: 14/847,457

(22) Filed: Sep. 8, 2015

(30) Foreign Application Priority Data
Sep. 19, 2014 (JP) 2014-191802

(51) Int. Cl. G06F 9/44; G06F 3/0484

(52) U.S. Cl. CPC G06F 8/34; G06F 3/0484

(57) ABSTRACT

A program information generating system includes an acquisition unit, a generating unit, and display control unit. The acquiring unit acquires program information which represents structure of a computer program and operation information which represents structure of operations. The generating unit generates first display information for generating a first display image which visually represents the structure of the computer program and second display information for generating a second display image which visually represents the structure of the operations. The program information includes section information which identifies a position of sections included in the computer program. The operation information includes section identification information which identifies the section corresponding to the operations. The generating unit generates the first display information and the second display information on the basis of the section information and the section identification information so that correspondence relationship between the sections and the operations becomes identifiable.

### CROSS-REFERENCE TO RELATED APPLICATION(S)

This application is based upon and claims the benefit of priority from Japanese Patent Application No. 2014-191802, filed on Sep. 19, 2014; the entire contents of which are incorporated herein by reference.

### FIELD

Embodiments described herein relate generally to a program information generating system, a program information generating method, and a computer program product.

### BACKGROUND

During the development of a computer program, a support tool is used that enables having objective understanding of the execution status of the computer program. For example, there are devices that generate an image representing the execution status of a computer program, and provide the image to the user using the display of a computer. Among such devices, for example, a device is available that displays an area representing the activities related to the overall execution status of a computer program and an area representing the detailed execution status of a particular range, and that enables the user to specify the particular range from the area representing the overall execution status.

However, in any such conventional support tool, for example, if the execution of a computer program leads to a greater amount of processing, then the image representing the execution status becomes complex thereby making it difficult to retrieve necessary information from the image.

### BRIEF DESCRIPTION OF THE DRAWINGS

FIG. 1 is a diagram illustrating a configuration of a program information generating system according to a first embodiment;

FIG. 2 is a diagram illustrating a hardware configuration of an information processing terminal and a server;

FIG. 3 is a diagram illustrating a functional configuration of the program information generating system;

FIG. 4 is a diagram illustrating a first source code;

FIG. 5 is a diagram illustrating a second source code;

FIG. 6 is a diagram illustrating section information of the entire first source code;

FIG. 7 is a diagram illustrating section information of the entire second source code;

FIGS. 8 and 9 are diagrams illustrating section information of single sections of the first source code;

FIGS. 10 to 12 are diagrams illustrating section information of single sections of the second source code;

FIGS. 13 to 15 are diagrams illustrating section information of single sections of the first source code;

FIGS. 16 to 19 are diagrams illustrating section information of single sections of the second source code;

FIG. 20 is a diagram illustrating first display method information;

FIGS. 21 to 36 are diagrams illustrating operation information;

FIG. 37 is a diagram illustrating second display method information;

FIG. 38 is a diagram illustrating a first display image;

FIG. 39 is a flowchart for explaining a flow of operations performed to display the first display image;

FIGS. 40 and 41 are diagrams illustrating an image in which the first display image and a second display image are displayed;

FIG. 42 is a diagram illustrating a specific example of the program information generating system according to the first embodiment;

FIG. 43 is a flowchart for explaining a flow of operations performed to display the first display image and the second display image in the specific example according to the first embodiment;

FIG. 44 is a diagram illustrating a functional configuration of a program information generating system according to a second embodiment;

FIG. 45 is a diagram illustrating selection information in a first display example according to the second embodiment;

FIG. 46 is a diagram illustrating section identification information in the first display example according to the second embodiment;

FIG. 47 is a diagram illustrating first display method information in the first display example according to the second embodiment;

FIG. 48 is a diagram illustrating the first display image and the second display image in the first display example according to the second embodiment;

FIG. 49 is a diagram illustrating first display method information in a second display example according to the second embodiment;

FIG. 50 is a diagram illustrating the first display image and the second display image in the second display example according to the second embodiment;

FIG. 51 is a diagram illustrating selection information in a third display example according to the second embodiment;

FIG. 52 is a diagram illustrating section identification information in the third display example according to the second embodiment;

FIG. 53 is a diagram illustrating first display method information in the third display example according to the second embodiment;

FIG. 54 is a diagram illustrating the first display image and the second display image in the third display example according to the second embodiment;

FIG. 55 is a diagram illustrating first display method information in a fourth display example according to the second embodiment;

FIG. 56 is a diagram illustrating the first display image and the second display image in the fourth display example according to the second embodiment;

FIG. 57 is a diagram illustrating first display method information in a fifth display example according to the second embodiment;

FIG. 58 is a diagram illustrating the first display image and the second display image in the fifth display example according to the second embodiment;

FIG. 59 is a flowchart for explaining a flow of operations performed to display the first display image and the second display image according to the second embodiment;

FIG. 60 is a diagram illustrating a functional configuration of a program information generating system according to a third embodiment;

FIG. 61 is a diagram illustrating an equation for generating the feature quantity information according to the third embodiment;

FIG. 62 is a diagram illustrating first display method information according to the third embodiment;

FIG. 63 is a diagram illustrating section identification information containing the feature quantity information according to the third embodiment;

FIG. 64 is a diagram illustrating the first display image and the second display image according to the third embodiment;

FIG. 65 is a flowchart for explaining a flow of operations performed to display the first display image and the second display image according to the third embodiment;

FIG. 66 is a diagram illustrating a functional configuration of a program information generating system according to a fourth embodiment

FIG. 67 is a diagram illustrating second display method information in a first display example according to the fourth embodiment;

FIG. 68 is a diagram illustrating the first display image and the second display image in the first display example according to the fourth embodiment;

FIG. 69 is a diagram illustrating second display method information in a second display example according to the fourth embodiment;

FIG. 70 is a diagram illustrating the first display image and the second display image in the second display example according to the fourth embodiment;

FIG. 71 is a diagram illustrating second display method information in a third display example according to the fourth embodiment;

FIG. 72 is a diagram illustrating the first display image and the second display image in the third display example according to the fourth embodiment;

FIG. 73 is a flowchart for explaining a flow of operations performed to display the first display image and the second display image according to the fourth embodiment;

FIG. 74 is a diagram illustrating a functional configuration of a program information generating system according to a fifth embodiment;

FIG. 75 is a diagram illustrating second display method information according to the fifth embodiment;

FIG. 76 is a diagram illustrating the first display image and the second display image according to the fifth embodiment; and

FIG. 77 is a flowchart for explaining a flow of operations performed to display the first display image and the second display image according to the fifth embodiment.

### DETAILED DESCRIPTION

According to one embodiment, a program information generating system includes an acquisition unit, a generating unit, and display control unit. The acquisition unit acquires program information which represents structure of a computer program and operation information which represents structure of operations generated as a result of execution of the computer program. The generating unit generates first display information for generating a first display image which represents the structure of the computer program on the basis of the program information, and second display information for generating a second display image which represents the structure of the operations on the basis of the operation information. The display control unit controls a display unit so that the first display image is displayed on the basis of the first display information and the second display image is displayed on the basis of the second display information. The program information includes section information which identifies a position of each of sections included in the computer program. The operation information includes section identification information which identifies the section corresponding to each of the operations. The generating unit generates the first display information and the second display information on the basis of the section information and the section identification information so that correspondence relationship between the sections and the operations becomes identifiable.

### First Embodiment

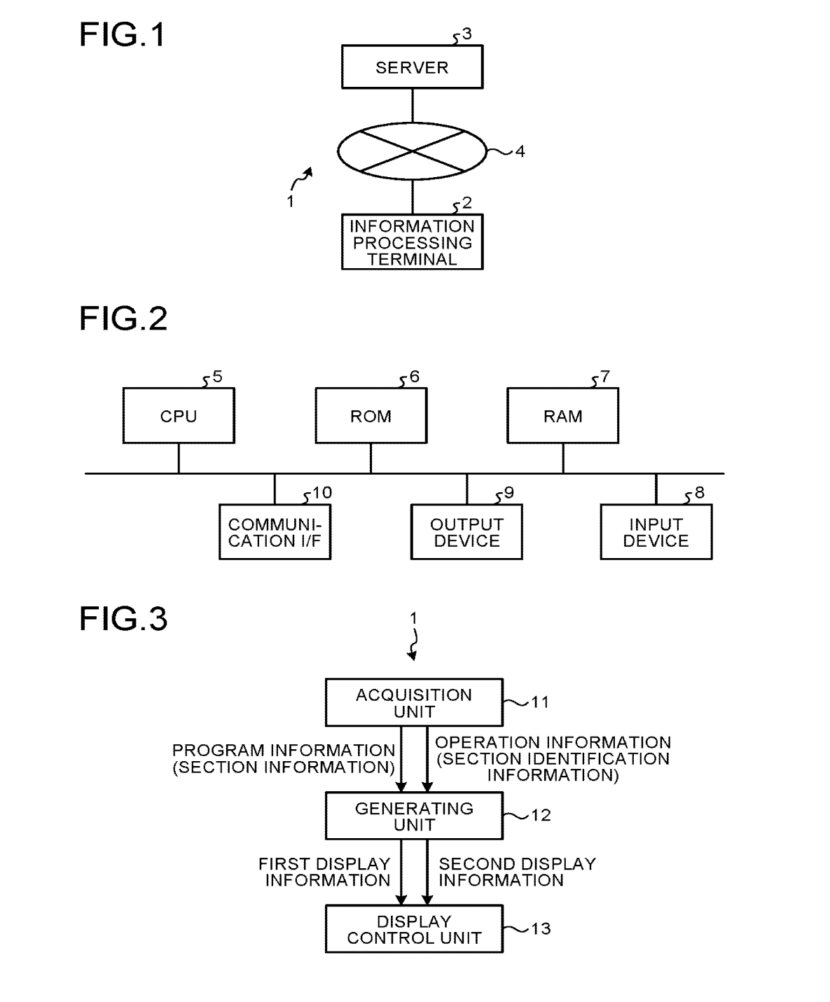

FIG. 1 is a diagram illustrating a configuration of a program information generating system 1 according to a first embodiment. The program information generating system 1 includes an information processing terminal 2 and a server 3, which are connected to each other via a network 4 such as the Internet. The information processing terminal 2 is an information processing device such as a personal computer or a tablet that is operable by a user. The server 3 performs at least some of the operations for generating an image to be displayed on a display unit of the information processing terminal 2. Meanwhile, in FIG. 1, although a single information processing terminal 2 and a single server 3 are illustrated, it is alternatively possible to have a plurality of information processing terminals 2 and a plurality of servers 3.

FIG. 2 is a diagram illustrating a hardware configuration of the information processing terminal 2 and the server 3. Herein, the information processing terminal 2 as well as the server 3 has the configuration of a commonly-used computer that includes a central processing unit (CPU) 5, a read only memory (ROM) 6, a random access memory (RAM) 7, an input device 8, an output device 9, and a communication interface (I/F) 10. The CPU 5 performs predetermined arithmetic processing according to a control program, which is stored in the ROM 6, using the RAM 7 as the working area. The input device 8 is a device such as a keyboard, a mouse, or a touch-sensitive panel that is used to input information from outside. The output device 9 is a device such as a display or a printer that outputs internally-generated information to the outside. The communication I/F 10 enables sending information to and receiving information from external devices via the network 4.

FIG. 3 is a diagram illustrating a functional configuration of the program information generating system 1. Herein, the program information generating system 1 includes an acquisition unit 11, a generating unit 12, and a display control unit 13.

The acquisition unit 11 acquires necessary information for generating an image that indicates the execution status of a computer program, which is to be tested and which is different than the control program used in controlling the CPU 5. Thus, in the following explanation, simply the term “computer program” indicates the computer program to be tested. The acquisition unit 11 is configured using the CPU 5, the ROM 6, the RAM 7, and the input device 8 of either the information processing terminal 2 or the server 3.

A computer program includes instructions written with respect to an information processing device, and represents a source code written in a programming language such as C language or JAVA (registered trademark) language. When a computer program is executed, it results in various operations such as controlling, filtering, and memory accessing. The operations are sometimes also called events or tasks. Moreover, a single operation may include a plurality of other operations. For example, an operation “operation 1”, which indicates one-time execution of a function, sometimes includes a plurality of operations such as memory accessing and instruction execution during the execution of “operation 1”.

The acquisition unit 11 acquires program information, operation information, and display method information. The program information represents information related to the structure of the computer program, and contains section information indicating the positions of one or more sections, which are included in the computer program. Herein, a section represents continuous regions that can be separated as a single unit from the perspective of functional attributes and the object of the source code.

The operation information indicates the attributes of operations, and contains section identification information which enables identification of the sections corresponding to the operations, that is, enables identification of the section which when executed result in each operation. According to the section identification information, if a particular operation is identified (selected), the corresponding section can be identified. Conversely, if a particular section is specified, then the corresponding operation can be identified.

The display method information is used in setting the display method of an image indicating the execution status of the computer program. According to the display method information, for example, setting is done for the following: the structure of the computer program; the structure of the operations; the correspondence relationship between the sections and the operations; and a display method (font, color, brightness, and shape) of an image object representing the section or the operation fitting in a predetermined condition.

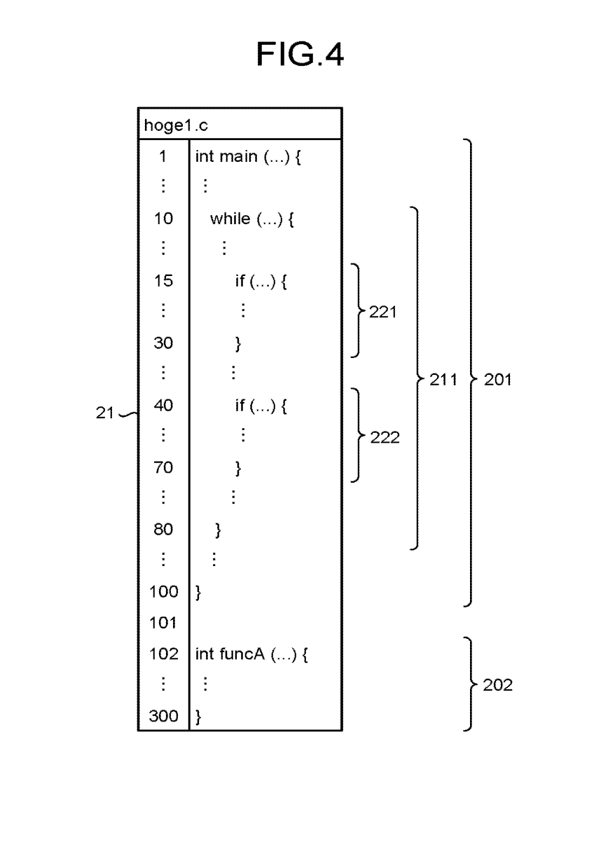

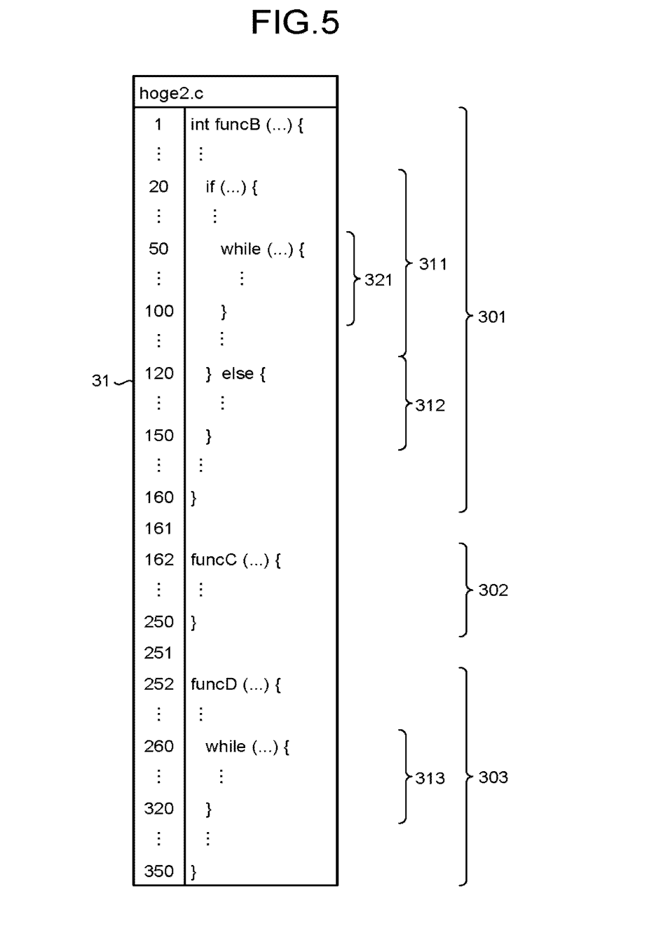

FIGS. 4 and 5 are diagrams illustrating a first source code 21 and a second source code 31 of a computer program that is responsible for the program information. In this example, the computer program is made of two files, namely, a file having “hoge1.c” as the file name (FIG. 4) and a file having “hoge2.c” as the file name (FIG. 5). In the first source code 21 and the second source code 31, the numbers written on the left-hand side represent line numbers, which are written for the purpose of illustration in the first embodiment but which are not explicitly written in the actual source code.

The first source code 21 includes sections 201 and 202. The section 201 includes a section 211, which in turn includes sections 221 and 222. In an identical manner, the second source code 31 includes sections 301 to 303. The section 301 includes sections 311 and 312, and the section 311 further includes a section 321. The section 303 includes a section 313. Moreover, the entire first source code 21 as well as the entire second source code 31 can also be treated as a single section.

In this way, the first source code 21 and the second source code 31 are written to have one or more sections arranged in a hierarchical manner. In the following explanation, the entire first source code 21 and the entire second source code 31 represent a first hierarchy level; the sections 201, 202, 301, 302, and 303 represent a second hierarchy level; the sections 211, 311, 312, and 313 represent a third hierarchy level; and the sections 221, 222, and 321 represent a fourth hierarchy level. Thus, from the first source code 21 and the second source code 31 (i.e., from the first hierarchy level), the hierarchy level reached at the n-th number of times is called the n-th hierarchy level. In this way, the hierarchy levels of the source codes 21 and 31 and the sections 201, 202, 211, 221, 222, 301, 302, 303, 311, 312, 313, and 321 are associated to each other.

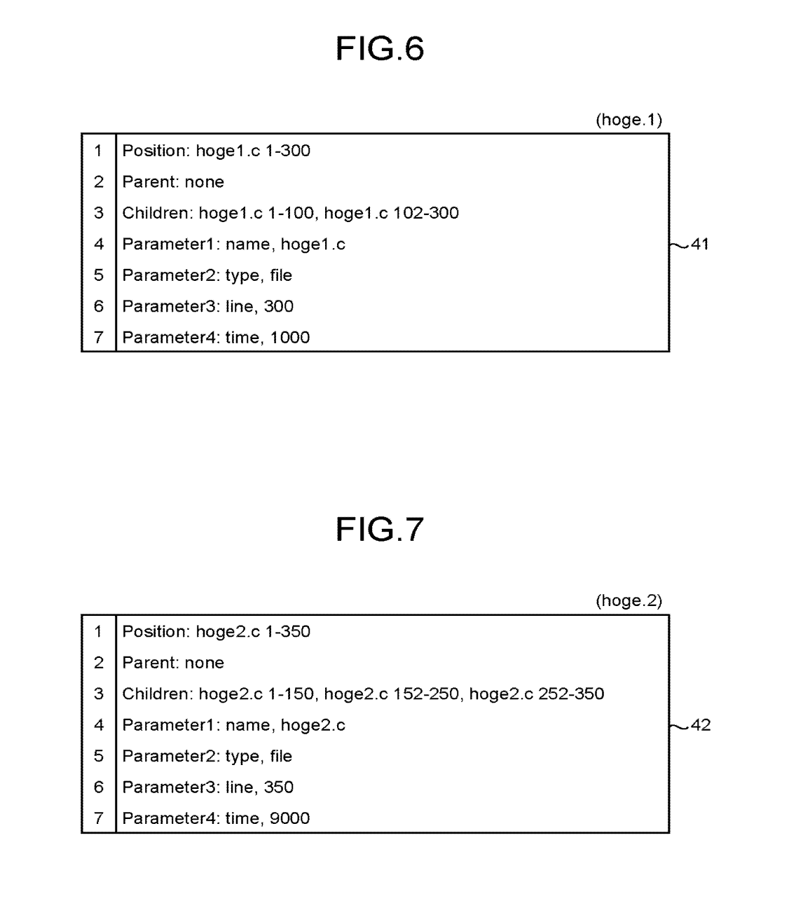

In FIGS. 6 to 19 are respectively illustrated section information 41 to section information 54. Each of the section information 41 to the section information 54 contains the following: “Position” representing source code position information; “Parent” and “Child” representing parent-child relationship information; and “Parameter” representing parameter information. The source code position information indicates the position of the concerned section in the source codes 21 and 31. The parent-child relationship information represents the parent-child relationship among the sections. The parameter information represents information that is acquirable in the section indicated by the source code position information and that indicates the execution status of the concerned status or the operation corresponding to the concerned status.

The parent-child relationship among the sections represents information indicating the relationship between the upper and lower hierarchy levels. For example, when there are two sets of section information and when a first section indicated by a first set of section information contains a second section indicated by a second set of section information, the first section becomes the parent of the second section, and the second section becomes the child of the first section. In an identical manner, when the first section indicated by the first set of section information is included in a third section indicated by a third set of section information, the first section becomes the child of the third section, and the third section becomes the parent of the first section.

The parent-child relationship information is used in identifying such parent-child relationship (also called inclusion relationship). The parent-child relationship information contains information (presence-absence information) indicating whether or not sections having the parent-child relationship are present; and contains information (parent identification information and child identification information) that, when sections having the parent-child relationship are present, is used in identifying the sections having the parent-child relationship. With reference to the example of the first to third sets of section information described above, the child identification information does not contain information for identifying the section included in the second section. Similarly, the parent identification information does not contain information for identifying the section including the third section.

Meanwhile, in the information indicating the presence or absence of section information having the parent-child relationship, instead of using information of independent nature, it is possible to use, for example, a combination of information used in identifying section information having the parent-child relationship and empty data (null).

The parameter information represents information indicating the internal state acquirable during the execution of the section indicated by the source code position information, and represents information acquirable from the source code of the section indicated by the source code position information. The information indicating the internal state may contain the execution period of the section indicated by the source code position information. Based on the execution period, it becomes possible to detect the latency in the concerned section or in the operation corresponding to the concerned section. The information acquirable from the source code may contain the number of lines of the source code within the region specified in the source code position information.

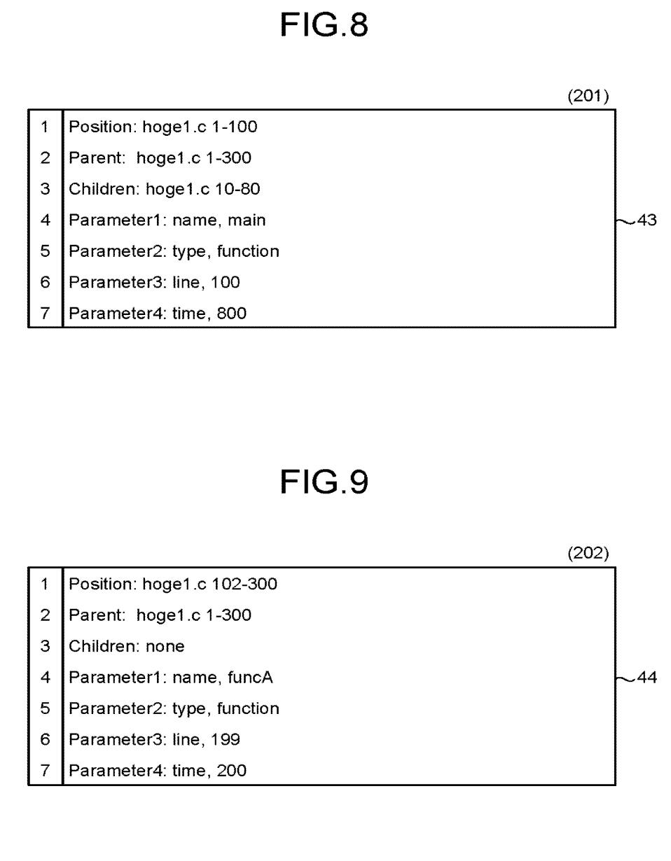

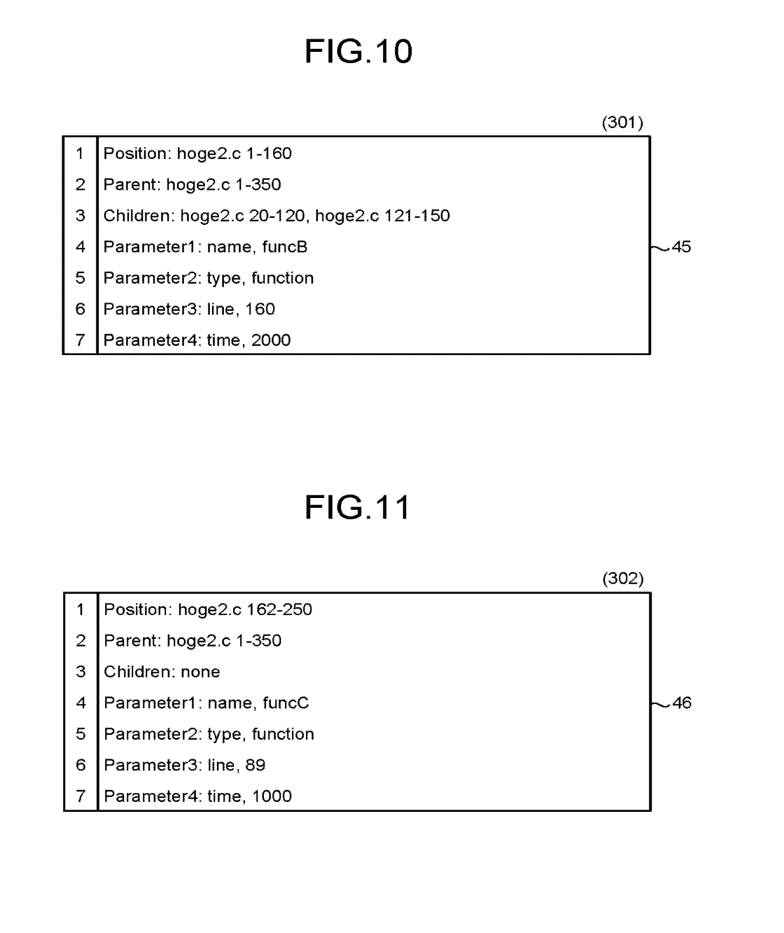

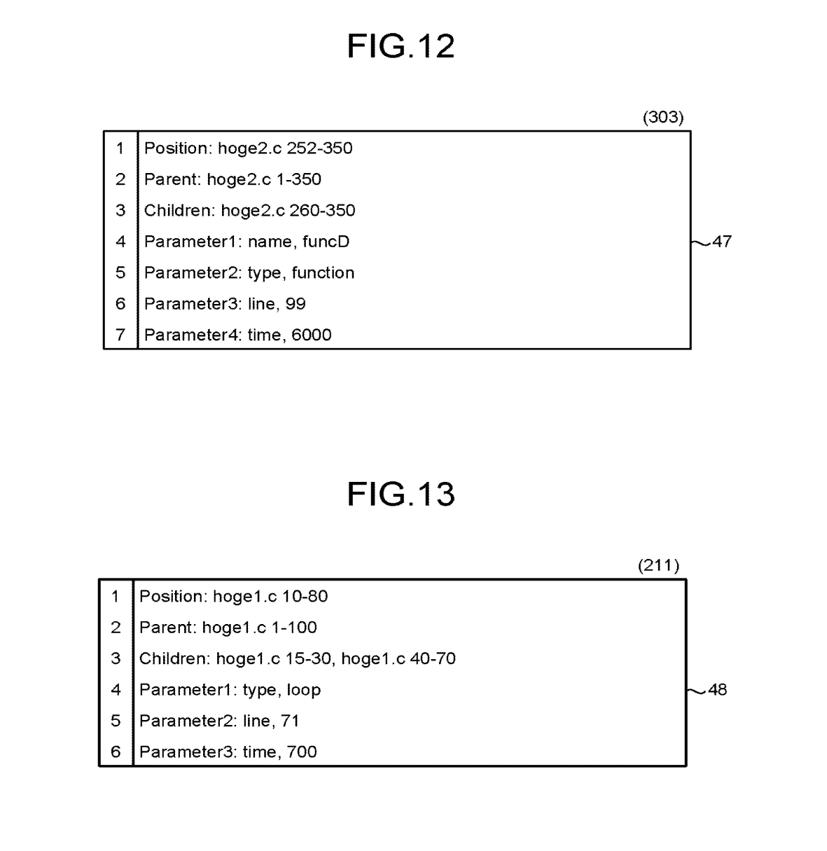

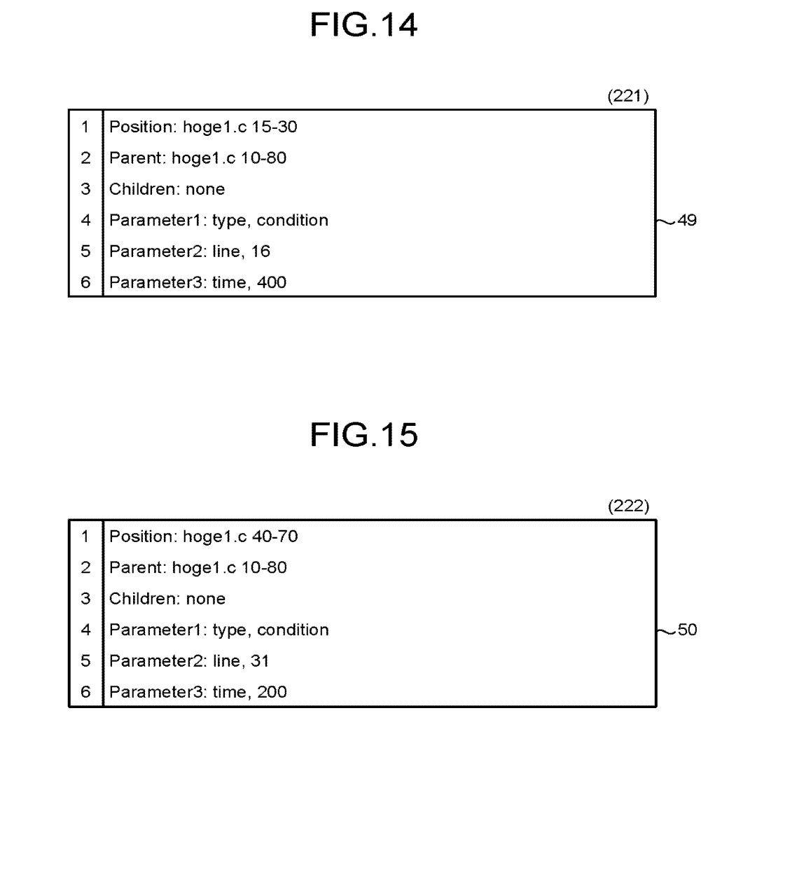

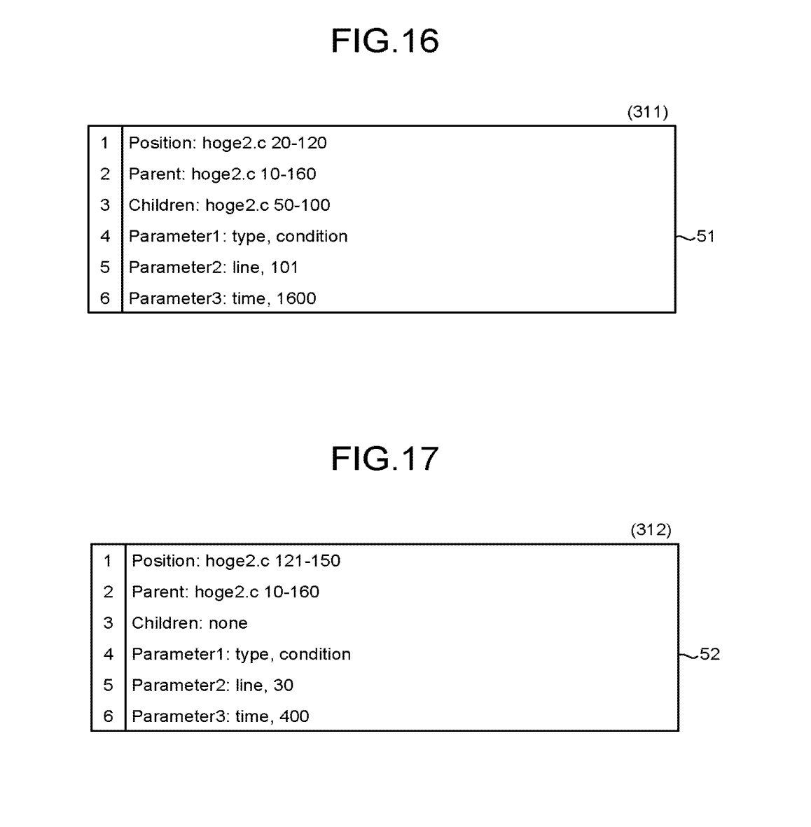

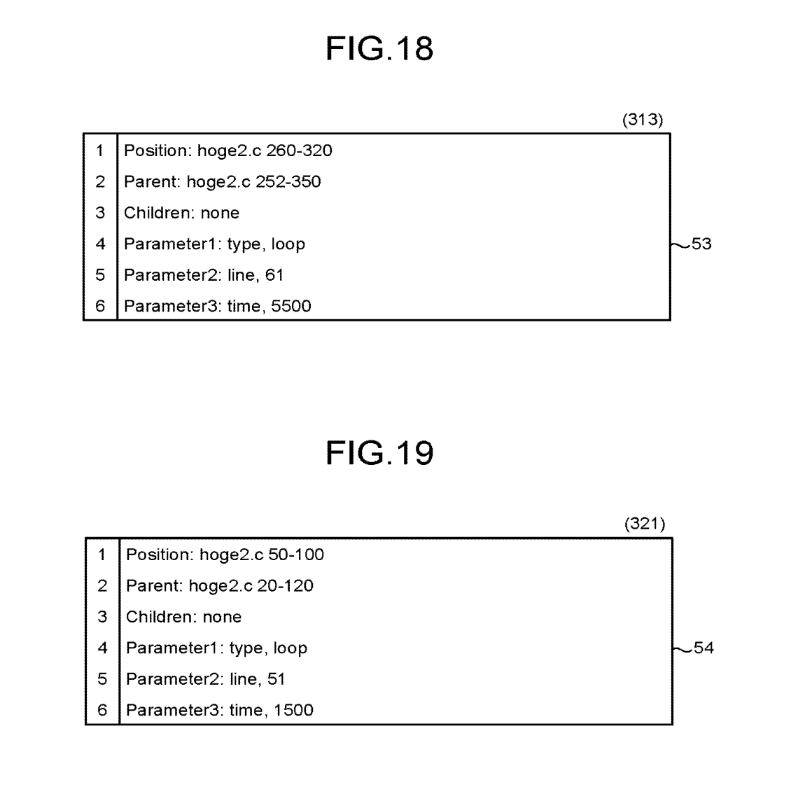

FIGS. 6 to 19 are diagrams illustrating the section information 41 to the section information 54 regarding the sections illustrated in FIGS. 4 and 5 (including the entire first source code 21 and the entire second source code 31 too). FIG. 6 is a diagram illustrating the section information 41 of the entire first source code 21. FIG. 7 is a diagram illustrating the section information 42 of the entire second source code 31. FIG. 8 is a diagram illustrating the section information 43 of the section 201 in the first source code 21. FIG. 9 is a diagram illustrating the section information 44 of the section 202 in the first source code 21. FIG. 10 is a diagram illustrating the section information 45 of the section 301 in the second source code 31. FIG. 11 is a diagram illustrating the section information 46 of the section 302 in the second source code 31. FIG. 12 is a diagram illustrating the section information 47 of the section 303 in the second source code 31. FIG. 13 is a diagram illustrating the section information 48 of the section 211 in the first source code 21. FIG. 14 is a diagram illustrating the section information 49 of the section 221 in the first source code 21. FIG. 15 is a diagram illustrating the section information 50 of the section 222 in the first source code 21. FIG. 16 is a diagram illustrating the section information 51 of the section 311 in the second source code 31. FIG. 17 is a diagram illustrating the section information 51 of the section 312 in the second source code 31. FIG. 18 is a diagram illustrating the section information 53 of the section 313 in the second source code 31. FIG. 19 is a diagram illustrating the section information 54 of the section 321 in the second source code 31. In the examples illustrated in FIGS. 6 to 19, the numbers written on the left-hand side represents the line numbers of the information, which are written for the purpose of illustration in the first embodiment but which are not explicitly written in the actual information.

In the examples illustrated in FIGS. 6 to 19, the first line represents the source code position information “Position”; the second line represents the parent information “Parent” of the parent-child relationship information; the third line represents the child information “Child” of the parent-child relationship information; and the fourth line onward (for example, in FIGS. 6 to 12, the fourth to seventh lines; and in FIGS. 13 to 19, the fourth to sixth lines) represent the parameter information “Parameter”.

Given below is the detailed explanation with reference to the example of the section information 41 corresponding to the entire first source code 21 illustrated in FIG. 6. The source code position information written at the first line indicates that the concerned section corresponds to a section from the first line to the 300-th line in the file having “hoge1.c” as the file name (having the first source code 21). The parent information written at the second line indicates that the section information about the parent is not available. The child information written at the third line indicates that the section corresponding to the first line to the 100-th line in the file “hoge1.c” and the section corresponding to the 102-nd line to the 300-th line in the file “hoge1.c” represent child sections.

Referring to the section written in the first source code 21, in between the first line to the 300-th line, the following two sections are present: the section 201 corresponding to the first line to the 100-th line and the section 202 corresponding to the 102-nd line to the 300-th line. In the section information 43 that is illustrated in FIG. 8 and that represents the section 201, it is indicated that the section information corresponding to the first line to the 300-th line in the file “hoge1.c” represents a parent section. Moreover, in the section information 41, the fourth line indicates that “name” indicating a function name is “hoge1.c”. The fifth line indicates that “type” indicating the type (attribute) of the section information is “file”. The sixth line indicates that “line” indicating the line in the source code to which the concerned section corresponds is the 300-th line. The seventh line indicates that “time” indicating the execution time of the concerned section is 1000 milliseconds.

In the section information 43 illustrated in FIG. 8 to the section information 47 illustrated in FIG. 12, the fifth line indicates that the type of the concerned section is “function” representing a function. In the section information 48 illustrated in FIG. 13, the section information 53 illustrated in FIG. 18, and the section information 54 illustrated in FIG. 19; the fourth line indicates that the type of the concerned section is “loop” representing iteration. In the section information 49 illustrated in FIG. 14 to the section information 52 illustrated in FIG. 17, the fourth line indicates that the type of the concerned section is “condition” representing conditional branching.

Regarding the section information 48 to the section information 54 of the two types “loop” and “condition”, it can be understood by referring to the first source code 21 and the second source code 31 that explicit names are not given. Hence, the section information 48 to the section information 54 do not contain “name”.

As described above, the program information intended for the first source code 21 illustrated in FIG. 4 and the second source code 31 illustrated in FIG. 5 contains the section information 41 illustrated in FIG. 6 to the section information illustrated in FIG. 19. As described above, by associating the sections and a variety of parameter information, it becomes possible to achieve abstraction by having connection between the execution status of the computer program and the sections. As a result, it becomes possible to track the state of each section in the first source code 21 and the second source code 31.

Moreover, if each of the section information 41 to the section information 54 have a parent-child relationship, it becomes possible to manage the parent-child relationship from the sections at low hierarchy levels to the sections at high hierarchy levels. For that reason, abstraction of the information about the sections at low hierarchy levels can be achieved using the information about the sections at high hierarchy levels. For example, in the case of displaying a structure having multiply-intricate loops, if the information about the topmost loop is displayed along with the information about the sections at low hierarchy levels, the display can be made more user-friendly. Conversely, the information about the sections at high hierarchy levels can be refined using the information about the sections at low hierarchy levels.

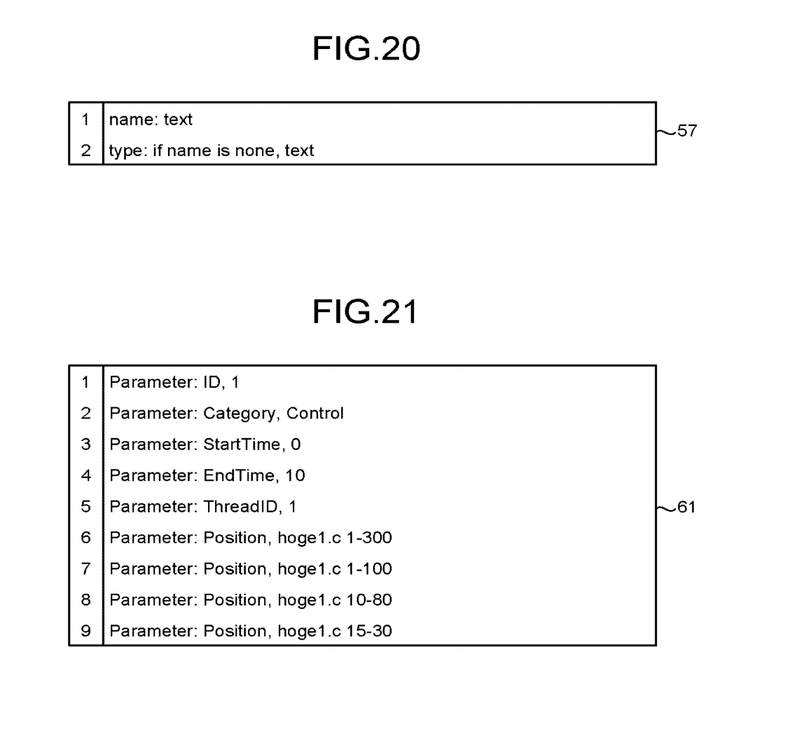

FIG. 20 is a diagram illustrating first display method information 57 used in determining the display method of an image representing the structure of the computer program (a first display image 101 (described later)). In the first display method information 57, the first line indicates that the contents of “name” are displayed in the text format; while the second line indicates that, when the section information 41 to the section information 54 does not contain “name”, the contents of “type” are displayed.

In addition, the first display method information 57 may also contain the following: “position: order” indicating that the sections having the same parent section and the same depth with respect to the source code position information are displayed in ascending order; and “time: length” indicating that the length of the object representing the section (a section object 111 (described later)) is varied according to the value of “time”. For example, “position: order” indicates sorting in ascending order based on the start position indicated by the source code position information. Herein, the source code position information contains the file names and the line numbers as text information. Thus, for example, sorting in alphabetical order can be done based on the text information, and the sections having the same file name can be further sorted using the line numbers.

Meanwhile, when “time: length” is included, for example, in the case of side-by-side display of the objects corresponding to the sections having the same parent section and the same depth, the length of those objects can be varied according to the value of “time”.

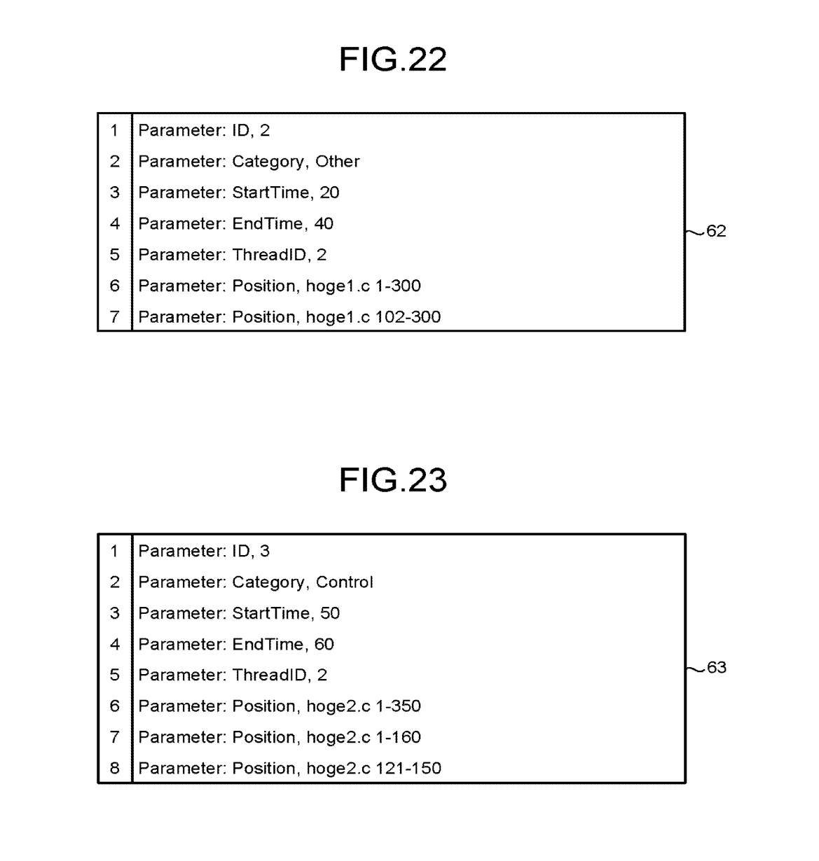

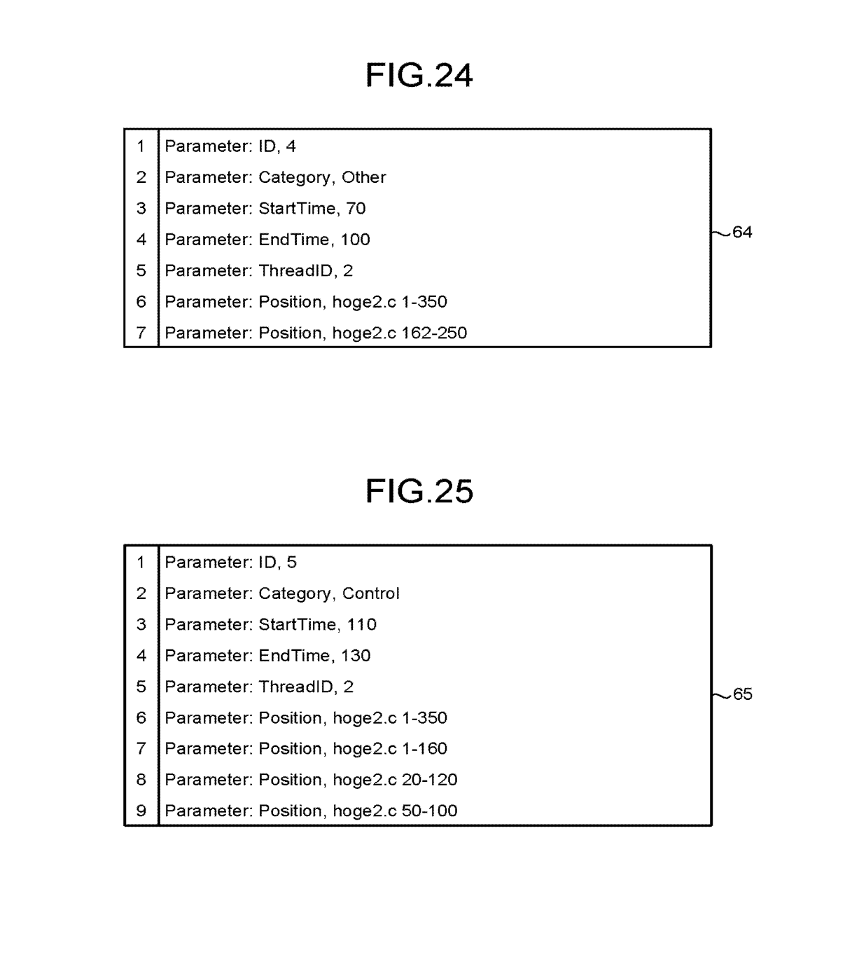

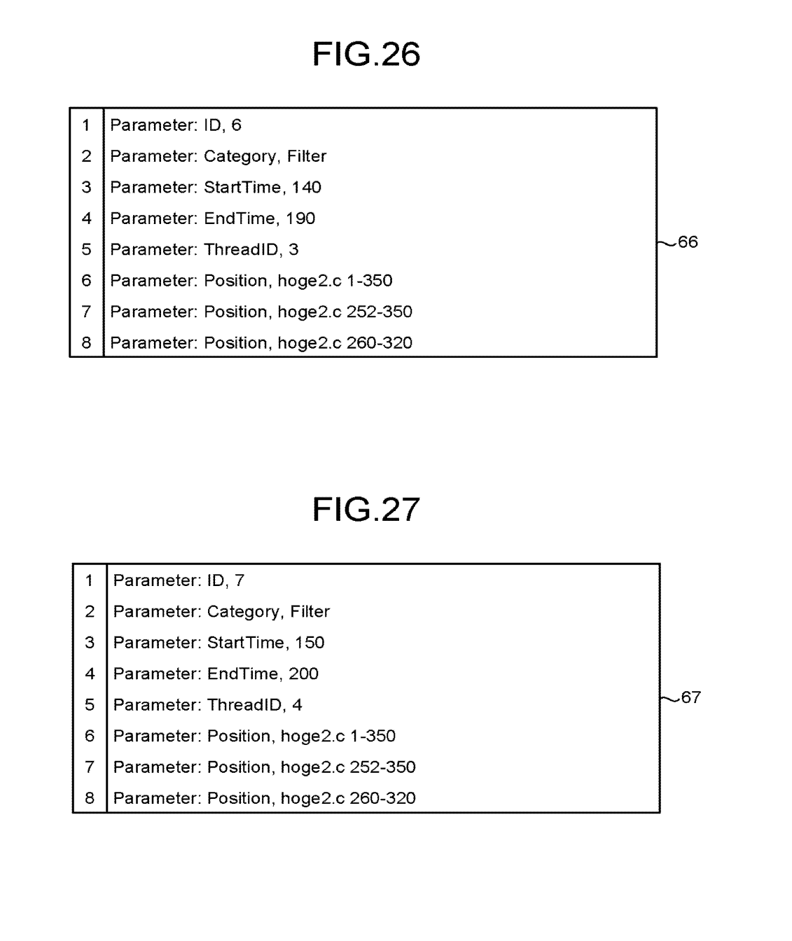

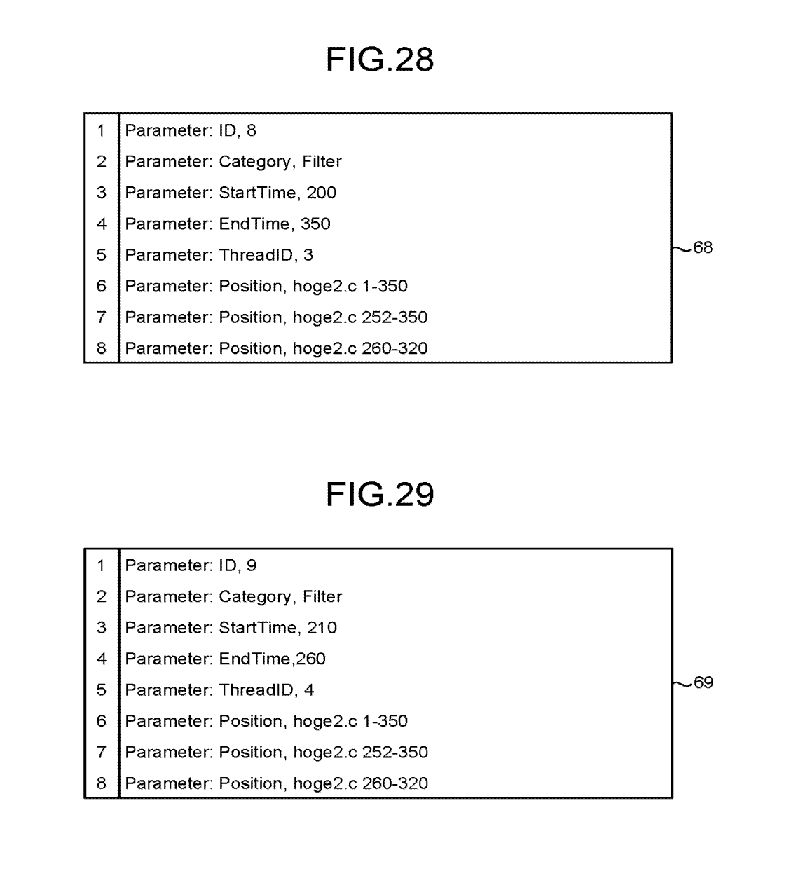

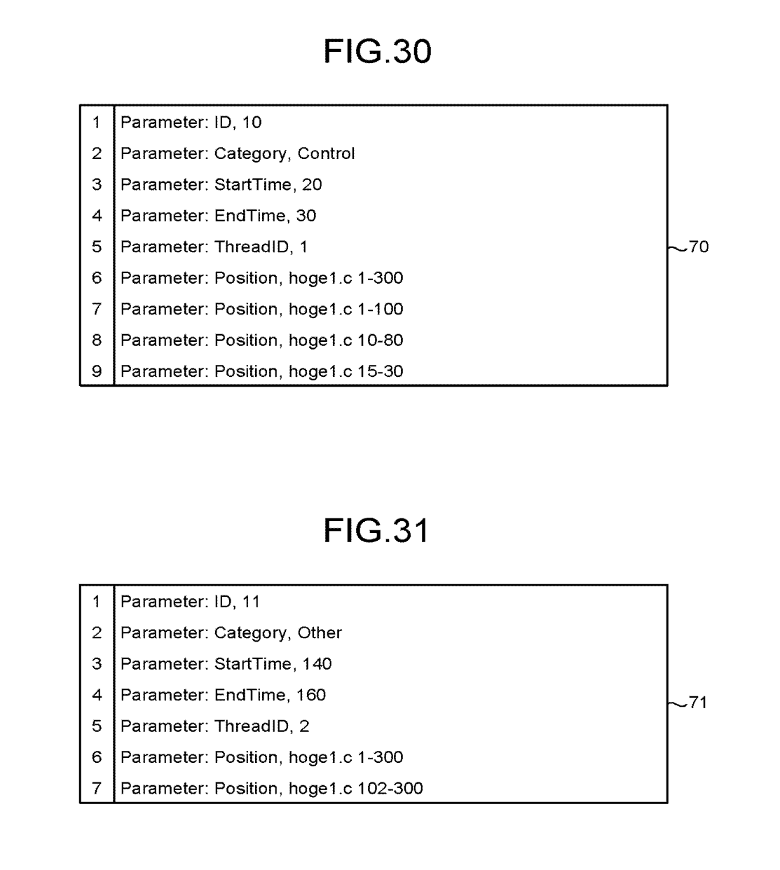

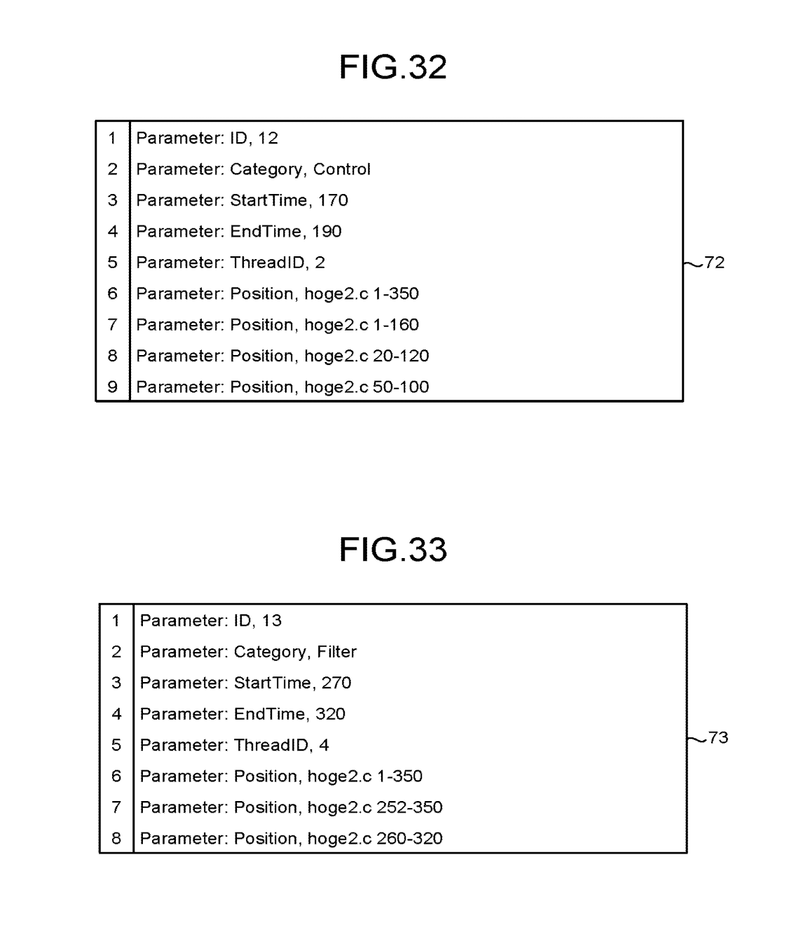

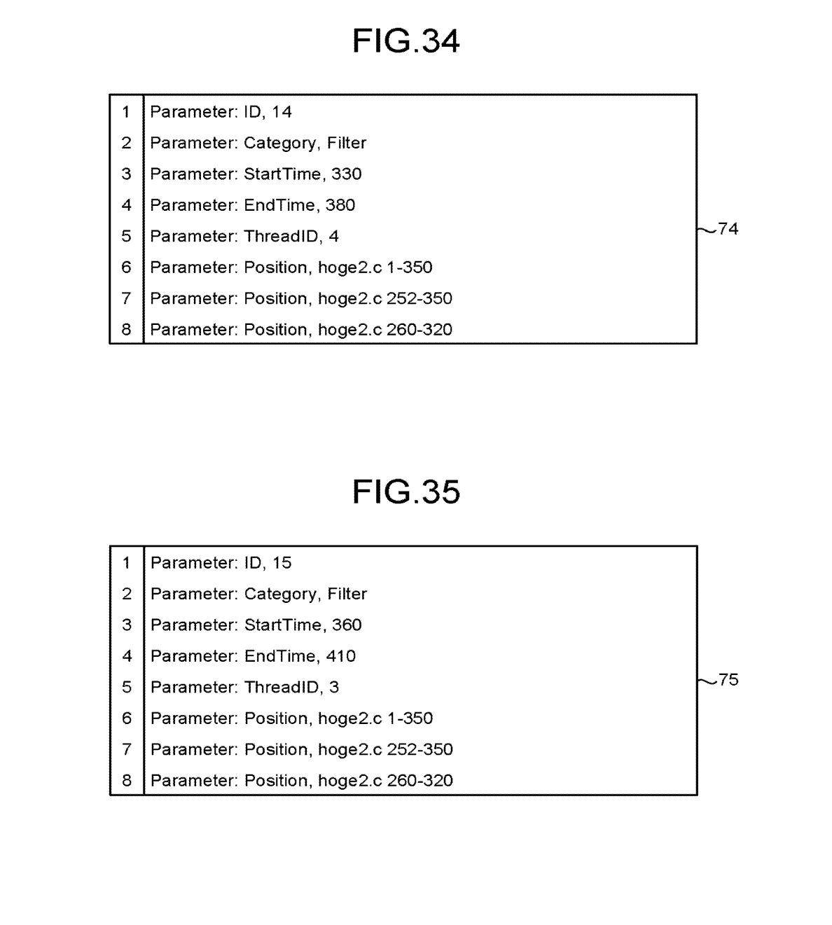

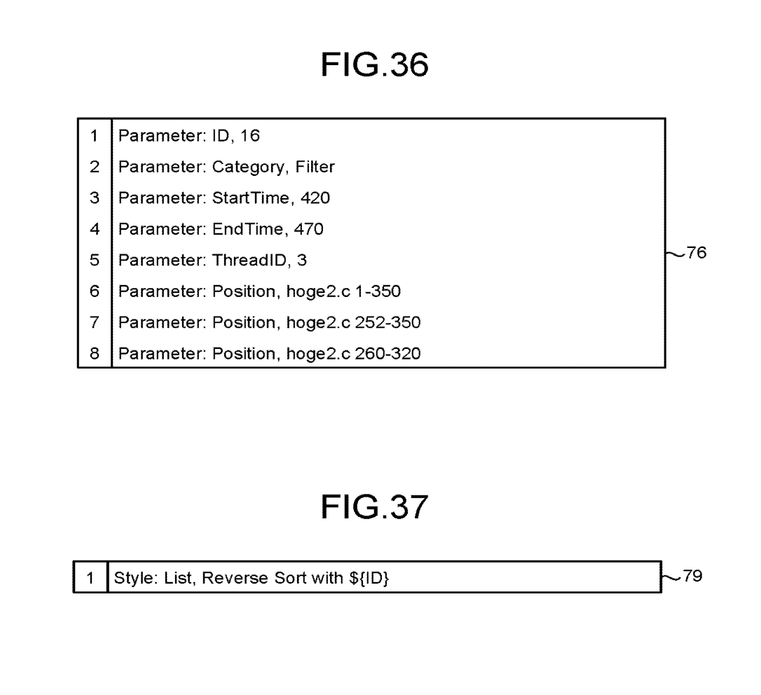

FIGS. 21 to 36 are diagrams illustrating operation information 61 to operation information 76, respectively. In this example, 16 operations are illustrated that are attributed to the execution of the first source code 21 illustrated in FIG. 4 and the second source code 31 illustrated in FIG. 5. In the operation information 61 illustrated in FIG. 21 to the operation information 76 illustrated in FIG. 36, the information (Parameter) represented by “ID”, “Category”, “StartTime”, “EndTime”, “ThreadID”, and “Position” is included. Herein, “ID” represents an identification number assigned in the units of operations. Moreover, “Category” represents information about the contents of the operation, and has three types of “Control”, “Filter”, and “Other”. Furthermore, “StartTime” represents information indicating the timing at which the concerned operation is started. Moreover, “EndTime” represents information indicating the timing at which the concerned operation is ended. Furthermore, “ThreadID” represents information about, for example, the core number of the CPU that performs the concerned operation. Moreover, “Position” represents section identification information and indicates the section, from among the sections 201 to 222 in the first source code 21 and the sections 301 to 321 in the second source code 31, to which the concerned operation corresponds.

For example, the operation information illustrated in FIG. 23 indicates the following: the operation assigned with “3” as “ID” belongs to “Control”; the operation starts at a timing “50” and ends at a timing “60”; the operation is executed by a CPU assigned with “2” as the core number; and the operation is attributed to the execution of the entire second source code 31 (1-350), the section 302 (1-160), and the section 312 (121-150).

FIG. 37 is a diagram illustrating second display method information 79 that is used in determining the display method of an image representing the structure on an operation (a second display image 102 (described later)). In this example, the second display method information 79 indicates that the structure of an operation is displayed in a list format in which the IDs are displayed in ascending order.

Meanwhile, the information such as the program information including the section information 41 to the section information 54, the operation information 61 to the operation information 76, the first display method information 57, and the second display method information is acquired, generated, and stored using the functions of the information processing terminal 2, or the functions of the server 3, or the functions of some other information processing device. The method for acquiring, generating, and storing such information should be appropriately designed according to the configuration and functions of the intended device and the intended network. For example, a computer program can either be acquired from a portable memory medium such as a compact disk read only memory (CD-ROM), a digital versatile disk (DVD), and a flash memory, or be acquired via the network 4. Moreover, the information can be input by an input operation performed by the user, or can be read from a predetermined memory device that is connected to the network 4 and that has the information stored therein in advance, or can be generated using a system for automatically analyzing the contents of computer programs. In this way, as long as the acquisition unit 11 can send the necessary information to the generating unit 12 (described later), the configuration can be in various forms.

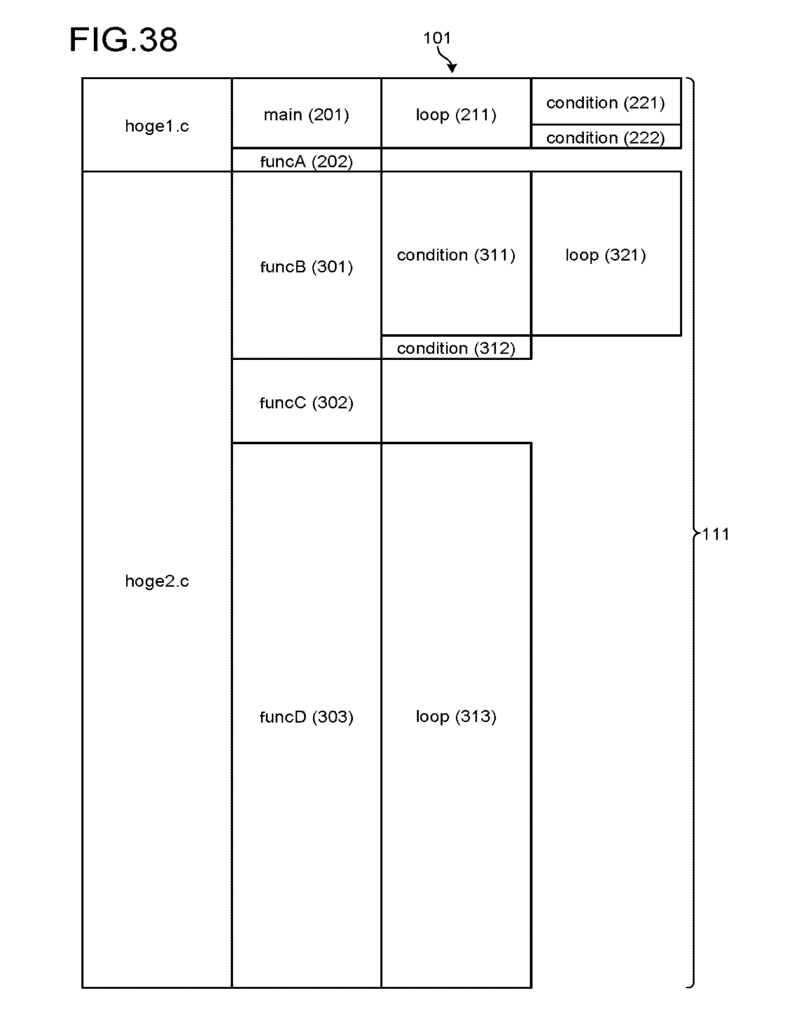

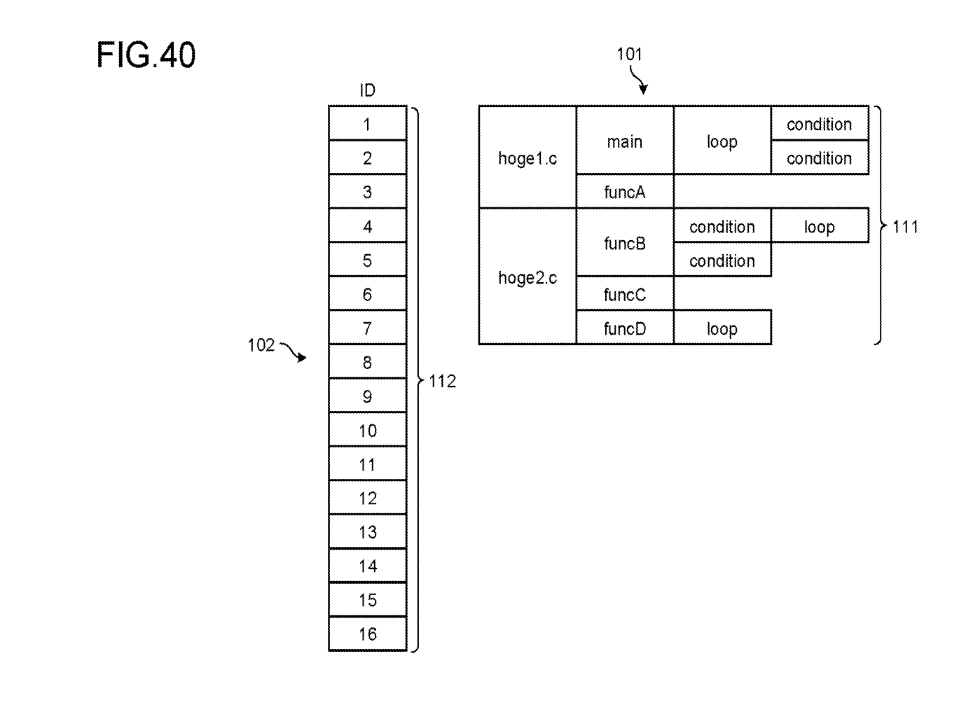

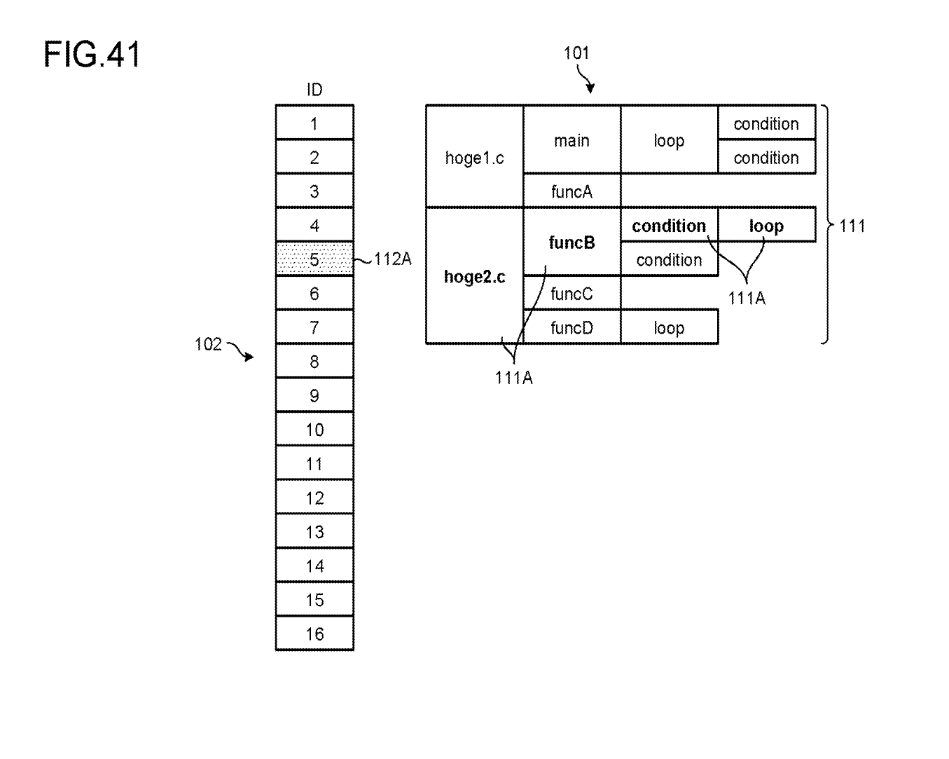

Based on the program information containing the section information 41 to the section information 54 and based on the first display method information 57, the generating unit 12 generates first display information to be used in displaying the first display image 101 that represents the structure of the concerned computer program. Moreover, based on the operation information 61 to the operation information 76 and based on the second display method information 79, the generating unit 12 generates second display information to be used in displaying the second display image 102 that represents the structure of the concerned operation. Based on the first display information and the second display information, the display control unit 13 controls a predetermined display unit in such a way that the first display image 101 and the second display image 102 are displayed. Herein, the predetermined display unit is, for example, the display of the information processing terminal 2 used by the user. FIG. 38 is a diagram illustrating the first display image 101. FIGS. 40 and 41 are diagrams illustrating side-by-side display of the first display image 101 and the second display image 102.

As illustrated in FIG. 38, the first display image 101 includes a plurality of section objects 111, each of which is an image object corresponding to one of the sections included in the computer program (i.e., the sections hoge1.c, hoge2.c, 201, 202, 211, 221, 222, 301, 302, 303, 311, 312, 313, and 321). The display method of each section object 111 differs according to the position (hierarchy level), the parent-child relationship, the execution period, and the attribute (type name) of the corresponding section. Herein, the display method represents the arrangement position, the shape, the size, the font, the color, and the brightness of the section objects 111. Meanwhile, in this example, the numbers written in brackets in the first display image 101 are given for the purpose of making it easier to understand the correspondence between FIG. 38 and FIGS. 4 and 5. However, those numbers are not displayed in the actual image.

Examples of the method for determining the arrangement position include a method of arranging the section objects 111 in a coordinate system in which the horizontal axis represents the depth from the source section and the vertical axis represents the positional relationship in the source codes 21 and 31. Herein, the source section represents the section serving as the source in setting the range for displaying the section objects, and represents one or more sections having the same depth from a reference section. Herein, the reference section is, for example, a section not having any parent section.

Among the section information 41 illustrated in FIG. 6 to the section information 54 illustrated in FIG. 19, the entire first source code 21 and the entire second source code 31 serve as the reference sections. In FIGS. 6 and 7, the parent information in the section information 41 and the section information 42 is “none” indicating that there are no sections serving as respective parent sections.

The depth of a reference section represents the number of parent sections present until reaching the reference section as a result of tracking the parent sections from a particular section, or represents the number of child sections present until reaching a particular section as a result of tracking child sections from the reference section to that particular section. Herein, the explanation is given about the case of tracking parent sections.

For example, in the case of the section information 49 illustrated in FIG. 14, the parent information is “hoge1.c 10-80”. Hence, it can be understood that the section 221 corresponding to the section information 49 has the section 211, which corresponds to the section information 48 illustrated in FIG. 13, as the parent section. In an identical manner, it can be understood that the section information 48 illustrated in FIG. 13 has the section 201, which corresponds to the section information 43 illustrated in FIG. 8, as the parent section. Moreover, it can be understood that the section information 43 illustrated in FIG. 8 has the entire first source code 21, which corresponds to the section information 41 illustrated in FIG. 6, as the parent section. Since the entire first source code 21 serves as a reference section, there are three parent sections in between the section 221, which corresponding to the section information 49 illustrated in FIG. 14, and the reference section. Hence, the section 221 has the depth equal to three from the reference section. Meanwhile, a reference section has the depth equal to zero.

As far as calculating the depth from a source section is concerned, the source section is used instead of using the reference section in the abovementioned method of calculating the depth from the reference section. However, depending on the selection of the source section, there can be sections from which the source section cannot be reached even if parent sections are tracked, or from which the section information cannot be reached even if child sections are tracked. Such sections are considered to have no depth, and can be removed from the display targets.

In the following explanation, it is assumed that the reference sections (the entire first source code 21 and the entire second source code 31) are set as source sections. In this example, since the horizontal axis represents the depth from the source sections, calculation of the depth from the source sections needs to be performed regarding each of the section information 41 to the section information 54.

In an identical manner to the case of calculating “3” as the depth of the section 221 corresponding to the section information 49 illustrated in FIG. 14, if the depths of the other sections are calculated, the following result is obtained. The first source code 21 and the second source code 31 have “0” as the depth. The section 201 corresponding to the section information 43 illustrated in FIG. 8 has “1” as the depth. The section 202 corresponding to the section information 44 illustrated in FIG. 9 has “1” as the depth. The section 301 corresponding to the section information 45 illustrated in FIG. 10 has “1” as the depth. The section 302 corresponding to the section information 46 illustrated in FIG. 11 has “1” as the depth. The section 303 corresponding to the section information 47 illustrated in FIG. 12 has “1” as the depth. The section 211 corresponding to the section information 48 illustrated in FIG. 13 has “2” as the depth. The section 221 corresponding to the section information 49 illustrated in FIG. 14 has “3” as the depth. The section 222 corresponding to the section information 50 illustrated in FIG. 15 has “3” as the depth. The section 311 corresponding to the section information 51 illustrated in FIG. 16 has “2” as the depth. The section 312 corresponding to the section information 52 illustrated in FIG. 17 has “2” as the depth. The section 313 corresponding to the section information 53 illustrated in FIG. 18 has “2” as the depth. The section 321 corresponding to the section information 54 illustrated in FIG. 19 has “3” as the depth.

Based on the information indicating the depths from the source sections, all section objects 111 are arranged in the horizontal direction in descending order of depths. At this stage, the section objects 111 having the same depth are arranged at the same position.

Given below is the explanation about the arrangement in the vertical direction based on the parent-child relationship. In the case of arranging the section objects 111 in rectangular areas, in order to demonstrate the parent-child relationship, the length in the vertical axis direction of the section objects 111 of the parent sections is set to be equal to or greater than the sum of lengths in the vertical axis direction of the section objects 111 of all child sections. The section objects 111 of all child sections are fit into the vertical axis range of the section objects 111 of the parent sections. As a result, it becomes possible to easily understand the parent-child relationship in the entire source code.

Given below is the explanation about the display inside the section objects 111. The display method is set based on the first display method information 57. Regarding the section information 41 to the section information 47 that contain “name”, the information written after “name” is displayed as a text in the corresponding section object 111. For example, in the case of the section information 41 illustrated in FIG. 6, “hoge1.c” is displayed as a text in the section object 111. On the other hand, in the case of the section information 48 to the section information 54 not including “name”, the information written after “type” is displayed as a text in the corresponding section object 111. For example, in the case of the section information 48 illustrated in FIG. 13, “loop” is displayed as a text in the section object 111. Meanwhile, the display method is not necessarily limited to such a singular display method. That is, it is possible to combine various display methods.

Subsequently, the sets of section information having the same parent section and the same depth are arranged in the vertical direction based on the starting positions specified in the source code position information (Position).

Regarding the section information 41 and the section information 42 having “0” as the depth, since those sets of section information correspond to the entire source codes 21 and 31; the arrangement thereof in the vertical direction cannot be determined by comparing the starting positions. In such a case, it is possible to use the result of sorting “hoge1.c” and “hoge2.c” of “name” in alphabetical order. In that case, the section information 41 (hoge1.c) is positioned at a higher level and the section information 42 (hoge2.c) is positioned at a lower level. However, that is not the only possible determination method. Alternatively, various other methods can be implemented. Herein, the explanation is given for a case in which the display method is determined in advance. However, alternatively, the arrangement in the vertical direction can be determined using the description “position: order” and by referring to the first display method information 57.

Regarding the sections 201, 202, 301, 302, and 303 corresponding to the section information 43 to the section information 47, respectively, illustrated in FIGS. 8 to 12, respectively; all sections have “1” as the depth. The section 201 corresponding to the section information 43 and the section 202 corresponding to the section information 44 have the section corresponding to the section information 41 illustrated in FIG. 6 (i.e., the entire first source code 21: hoge1.c) as the parent section. Similarly, the section 301 corresponding to the section information 45, the section 302 corresponding to the section information 46, and the section 303 corresponding to the section information 47 have the section corresponding to the section information 42 illustrated in FIG. 7 (i.e., the entire second source code 31: hoge2.c) as the parent section. Meanwhile, the length in the vertical axis direction of the section object 111 of a parent section includes the section objects 111 of all child sections. Hence, according to the positional relationship between the section object 111 (hoge1.c) corresponding to the section information 41 and the section object 111 (hoge2.c) corresponding to the section information 42, the section objects 111 corresponding to the section information 43 and the section information 44 (i.e., the sections 201 and 202) are positioned at a higher level, and the section objects 111 corresponding to the section information 45 to the section information 47 (i.e., the sections 301, 302, and 303) are positioned at a lower level.

As illustrated in FIGS. 8 and 9, the section 201 corresponding to the section information 43 has the first line as the starting position, and the section 202 corresponding to the section information 44 has the 102-nd line as the starting position. As illustrated in FIG. 38, the sections 201 and 202 are displayed as child sections of the section hoge1.c. In this example, the arrangement in the vertical axis direction of those sections is done in ascending order of the starting positions. Thus, the section 201 having the first line as the starting position is positioned at a higher level, and the section 202 having the 102-nd line as the starting position is positioned at a lower level. In an identical manner, the sections 301 to 303, which correspond to the section information 45 to the section information 47, respectively, illustrated in FIGS. 10 to 12, respectively, are child sections of the section hoge2.c and have the first line, the 162-nd line, and the 252-nd line as the respective starting positions. For that reason, regarding the arrangement of the sections 301 to 303 in the vertical axis direction, within the range of the length in the vertical direction, the sections 301, 302, and 303 are arranged in that order from the top. The same is the case regarding the sections 211, 221, 222, 311, 312, 313, and 321 having the depth equal to or greater than two.

Subsequently, based on “time” specified in the section information 41 to the section information 54, the length of the vertical axis of the section objects 111 is varied. For example, regarding the sections having the same parent section and the same depth, the length of the vertical axis is varied in concert with the ratio of “time”. More particularly, in the section information 41 and the section information 42 having “0” as the depth, the value of “time” is 1000 and 9000, respectively. Hence, the section objects 111 corresponding to the sections hoge1.c and hoge2.c are set to have a ratio of 1:9 for the length of the vertical axis. Meanwhile, in this example, although the display method is determined in advance, it is alternatively possible to determine the display method using the description “time: length” mentioned above.

As illustrated in FIGS. 8 and 9, the sections 201 and 202 that are child sections of the section hoge1.c have the value of “time” equal to 800 and 200, respectively. For that reason, the ratio of lengths in the vertical axis direction of the section objects 111 in the sections 201 and 202 is set to be 4:1 within the range of the length of the vertical axis of the section object 111 of the section hoge1.c. In an identical manner, as illustrated in FIGS. 10 to 12, the sections 301, 302, and 303 that are child sections of the section hoge2.c have the value of “time” equal to 2000, 1000, and 6000, respectively. For that reason, the ratio of lengths in the vertical axis direction of the section objects 111 in the sections 301, 302, and 303 is set to be 2:1:6 within the range of the length of the vertical axis of the section object 111 of the section hoge2.c. The same is the case regarding the sections 211, 221, 222, 311, 312, 313, and 321 having the depth equal to or greater than two.

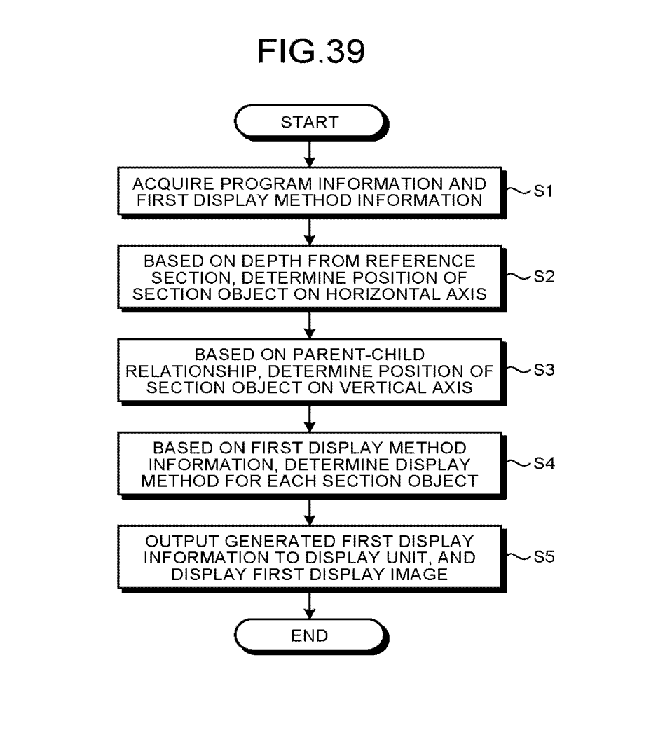

FIG. 39 is a flowchart for explaining a flow of operations performed to display the first display image 101. Firstly, the generating unit 12 acquires, from the acquisition unit 11, program information, which contains the section information 41 to the section information 54, and the first display method information 57 (S1). Then, based on the depth of the sections 201 to 222 from the reference section hoge1.c and based on the depth of the sections 301 to 321 from the reference section hoge2.c, the generating unit 12 determines positions of the section objects 111 on the horizontal axis (S2). Then, based on the parent-child relationship information “Parent” and “Child” specified in the section information 41 to the section information 54, the generating unit 12 determines the positions of the section objects 111 on the vertical axis (S3). Subsequently, based on the first display method information 57, the generating unit 12 determines the display method inside the section objects 111 (S4). That is, the generating unit 12 determines the font of the text displayed in the section objects 111 and determines the line type, the color, the design, and the shape of the frames of the section objects 111. Subsequently, the generating unit 12 generates first display information that contains the details of Steps S2 to S4; and the display control unit 13 controls the display unit in such a way that the first display image 101 is displayed based on the first display information (S5).

In the first embodiment, as illustrated in FIGS. 40 and 41, the second display image 102 is displayed next to the first display image 101. The second display image 102 includes one or more operation objects 112, which are image objects corresponding to the operations generated as a result of executing the computer program (the first source code 21 illustrated in FIG. 4 and the second source code 31 illustrated in FIG. 5) (i.e., image objects corresponding to the operations represented by the operation information 61 illustrated in FIG. 21 to the operation information 76 illustrated in FIG. 36). The numbers 1 to 16 assigned to the operation objects 112 correspond to the numbers of “Parameter: ID” specified in the operation information 61 illustrated in FIG. 21 to the operation information 76 illustrated in FIG. 36. In this way, as a result of displaying the first display image 101 and the second display image 102 next to each other, the structure of the computer program and the structure of the operations can be confirmed at the same time.

Meanwhile, one operation object 112A is displayed according to a different display method than the other operation objects 112, while some section objects 111A (hoge2.c, funcB, condition, and loop) are displayed according to a different display method than the other section objects 111. For example, the frame of the operation object 112A is displayed in a different color and brightness than the other operation objects 112, and the text of the section objects 111A is displayed in a different font (such as boldface) than the text of the other section objects 111.

The operation object 112A has a correspondence relationship with the section objects 111A. That is, the operation corresponding to the operation object 112A (the operation corresponding to the operation information 65 illustrated in FIG. 25) is generated as a result of executing the sections corresponding to the section objects 111A (i.e., the section hoge2.c corresponding to the section information 42 illustrated in FIG. 7, the section 301 corresponding to the section information 45 illustrated in FIG. 10, the section 311 corresponding to the section information 51 illustrated in FIG. 16, and the section 321 corresponding to the section information 54 illustrated in FIG. 19). Such correspondence relationship between an operation and a section can be determined based on the section identification information “Parameter: Position” specified in the operation information 61 to the operation information 76 and based on the source code position information “Position” specified in the section information 41 to the section information 54. In this way, as a result of identifiably displaying the correspondence relationship between an operation and a section, the execution status of the computer program can be visually understood in an accurate way.

Meanwhile, in the configuration illustrated in FIG. 1, the information processing terminal 2 and the server 3 are connected via the network 4. However, the embodiments of the program information generating system 1 are not limited to that case. For example, the configuration may not include the network 4 such as the Internet. Alternatively, a single computer or a plurality of computers can be controlled using a predetermined control program so as to implement the acquisition unit 11, the generating unit 12, and the display control unit 13. That is, the program information generating system 1 can be configured using stand-alone hardware components. The display unit for displaying the first display image 101 and the second display image 102 can be in various forms, and need not always be included in the program information generating system 1. Examples of the display unit include the display of an arbitrary information processing terminal such as a person computer, a tablet, and a smartphone; and a printing device. The display control unit 13 outputs the first display information and the second display information to the display unit, and thus can display the first display image 101 and the second display image 102 on the display unit.

### SPECIFIC EXAMPLE

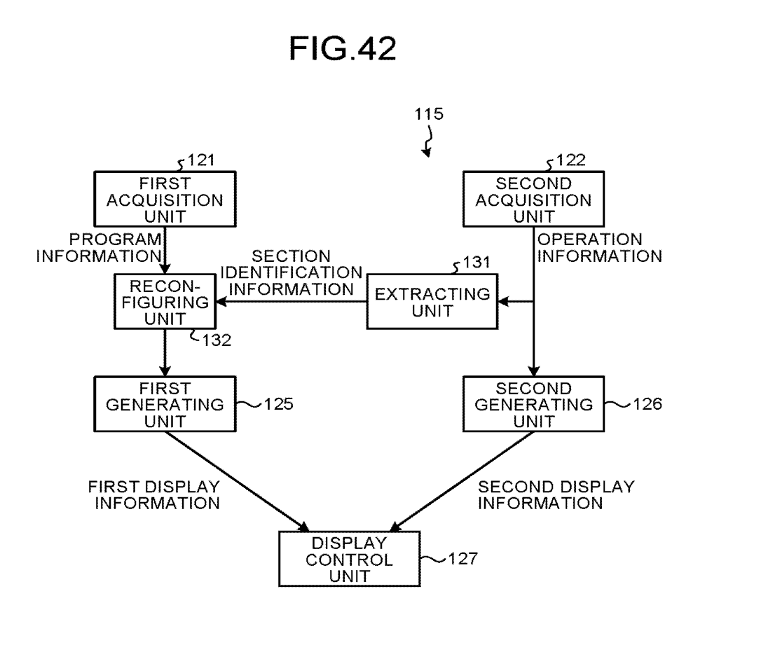

FIG. 42 is a diagram illustrating a specific example of the program information generating system according to the first embodiment. This specific example is about displaying an image that represents the correspondence relationship between an operation and a section as illustrated in FIG. 41. According to this specific example, a program information generating system 115 includes a first acquisition unit 121, a second acquisition unit 122, a first generating unit 125, a second generating unit 126, a display control unit 127, an extracting unit 131, and a reconfiguring unit 132.

The first acquisition unit 121 acquires the program information that contains the section information 41 to the section information 54. The second acquisition unit 122 acquires the operation information 61 to the operation information 76.

The extracting unit 131 extracts the section identification information “Parameter: Position” from the operation information 61 to the operation information 76. The reconfiguring unit 132 reconfigures the program information, which is acquired by the first acquisition unit 121, in order to enable identification of the section having the source code position information “Position” that matches with the extracted section identification information.

For example, regarding the operation information 65 having the parameter ID,5 as illustrated in FIG. 25, the section identification information represents “hoge2.c 1-350”, “hoge2.c 1-160”, “hoge2.c 20-120”, and “hoge2.c 50-100” written in the sixth to ninth lines. The sections having the source code position information “Position” matching with the sets of section identification information are: the section corresponding to the section information 42 illustrated in FIG. 7; the section corresponding to the section information 45 illustrated in FIG. 10; the section corresponding to the section information 51 illustrated in FIG. 16; and the section corresponding to the section information 54 illustrated in FIG. 19 (i.e., the sections “name: hoge2.c”, “name: funcB”, “type: condition”, and “type: loop”). The reconfiguring unit 132 sets a flag for the section information of the identified sections, and generates new information by extracting those sets of section information.

The first generating unit 125 generates, based on the program information reconfigured by the reconfiguring unit 132 and based on the first display method information 57, the first display information used in displaying the first display image 101 as illustrated in FIG. 41. The second generating unit 126 generates, based on the operation information 61 to the operation information 76 acquired by the second acquisition unit 122 and based on the second display method information 79, the second display information used in displaying the second display image 102 as illustrated in FIG. 41. The display control unit 127 controls the display unit in such a way that the first display image 101 and the second display image 102 are displayed based on the first display information and the second display information.

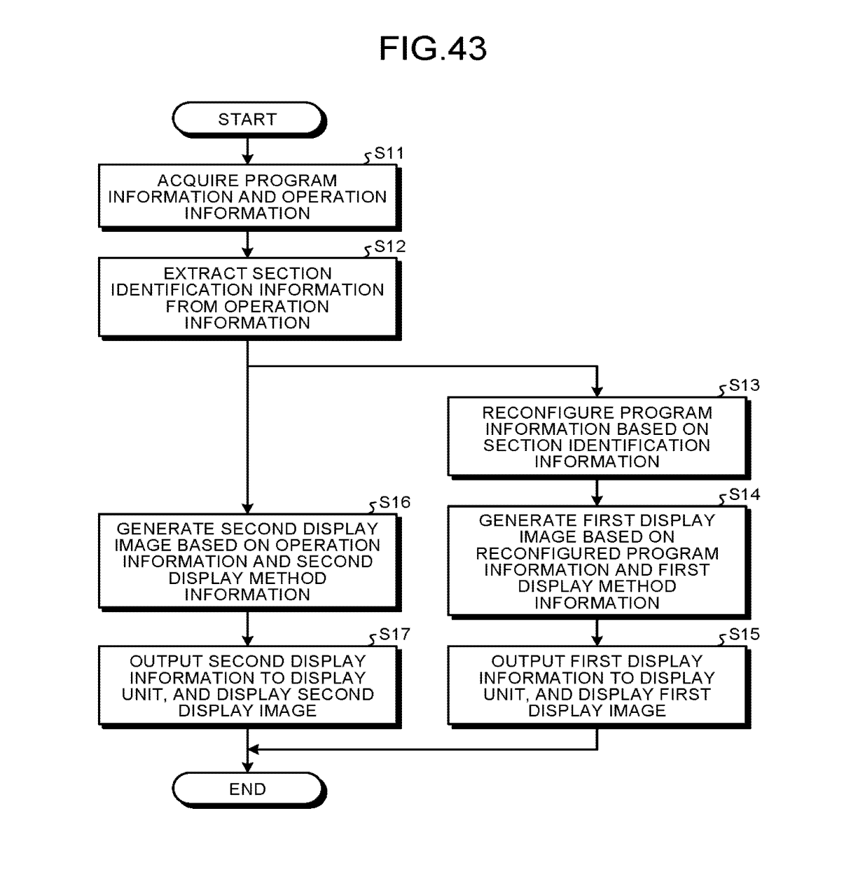

FIG. 43 is a flowchart for explaining a flow of operations performed to display the first display image 101 and the second display image 102 in this specific example. The first acquisition unit 121 acquires the program information containing the section information 41 to the section information 54, and the second acquisition unit 122 acquires the operation information 61 to the operation information 76 (S11). The extracting unit 131 extracts the section identification information from the operation information 61 to the operation information 76 (S12). Based on the extracted section identification information, the reconfiguring unit 132 reconfigures the program information so as to enable identification of the sections corresponding to a predetermined operation (S13). Based on the reconfigured program information and the first display method information 57, the first generating unit 125 generates the first display information used in displaying the first display image 101 (S14). Based on the first display information, the display control unit 127 displays the first display image 101 on the display unit (S15). Meanwhile, based on the operation information 61 to the operation information 76 and based on the second display method information 79, the second generating unit 126 generates the second display information used in displaying the second display image 102 (S16). Based on the second display information, the display control unit 127 displays the second display image 102 on the display unit (S17).

### Second Embodiment

Explained below with reference to the accompanying drawings are other embodiments. Regarding the details having an identical function effect to that explained in the first embodiment, the same reference numerals are used and the explanation is sometimes not repeated.

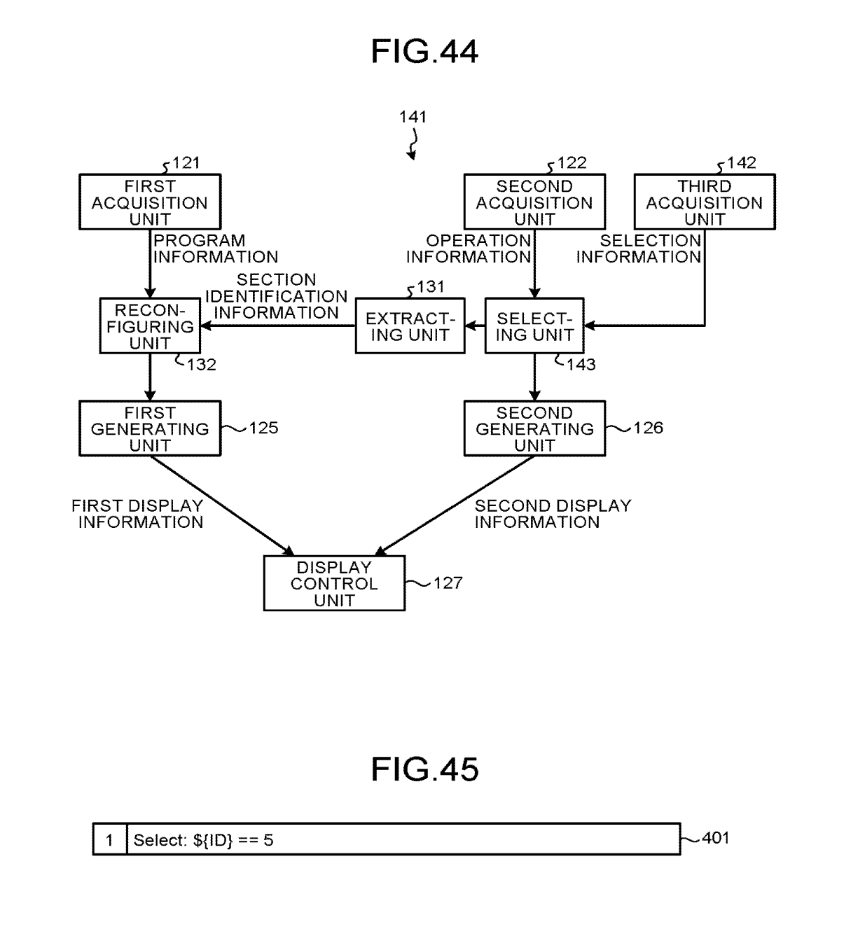

FIG. 44 is a diagram illustrating a functional configuration of a program information generating system 141 according to a second embodiment. As compared to the program information generating system 115 illustrated in the specific example in FIG. 42 according to the first embodiment, the program information generating system 141 according to the second embodiment differs in the way that a third acquisition unit 142 and a selecting unit 143 are additionally included.

The third acquisition unit 142 acquires selection information, which enables identification of the selected operation from among one or more operations. Examples of the selection information include a list of ID numbers included in the operation information 61 to the operation information 76; information attributed to the regular expression format; and information written in the node selection syntax XPath in XML language. However, those are not the only possible examples.

The selecting unit 143 outputs, to the second generating unit 126 and the extracting unit 131, the operation information 61 to the operation information 76 corresponding to the operation selected based on the selection information. At the time, either only the information related to the selected operation may be output, or all or some of the operation information 61 to the operation information 76 may be output after setting a flag that enables identification of the selected operation. Meanwhile, there may be a case in which, depending on the selection information, not even a single set of operation information can be selected. In such a case, for example, it is desirable to respond by displaying warning information on the display unit.

### First Display Example

FIG. 45 is a diagram illustrating selection information 401 in a first display example. In this example, the selection information 401 indicates that the operation having “5” as the ID is to be selected. Such selection can be performed by the user on the screen using a mouse, a touch-sensitive panel, or a keyboard. However, that is not the only possible case. Alternatively, for example, it is possible to use software that automatically selects an operation satisfying predetermined conditions.

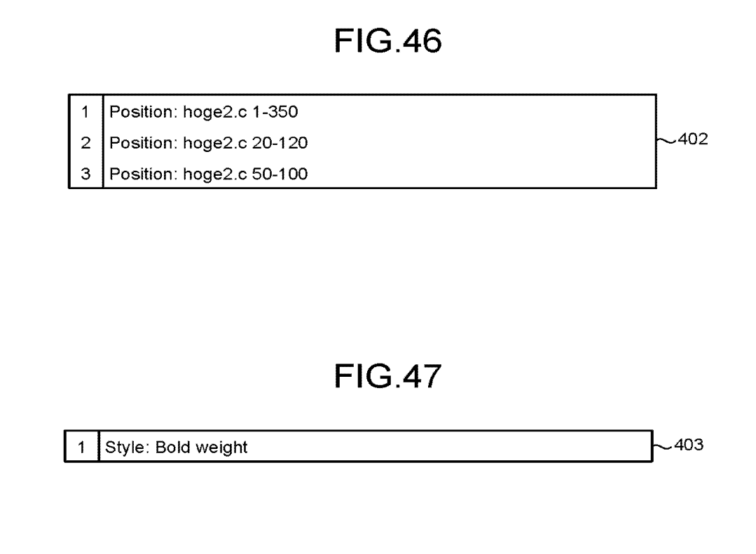

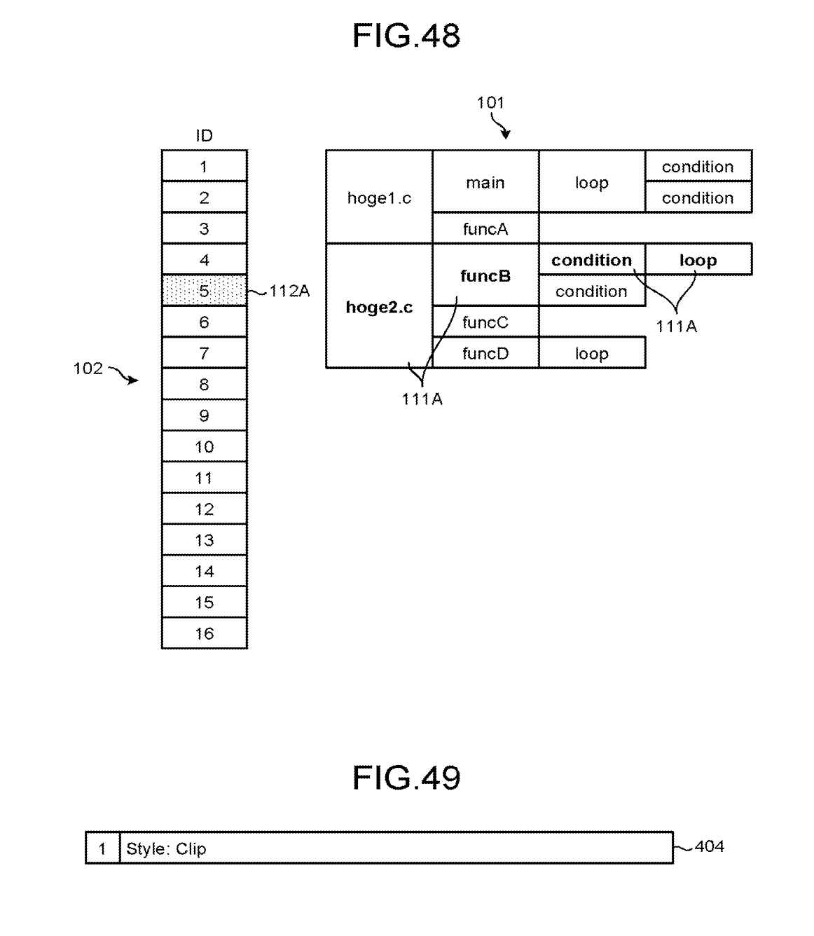

FIG. 46 is a diagram illustrating section identification information 402 in the first display example. FIG. 47 is a diagram illustrating first display method information 403 in the first display example. FIG. 48 is a diagram illustrating the first display image 101 and the second display image 102 in the first display example. In this example, the first display method information 403 enables setting of the display method for identifiably displaying the section corresponding to the selected operation, and is set in such a way that the section object 111A of the section corresponding to the selected operation (the operation object 112A) has the characters displayed in boldface. In FIG. 48, the section objects 111A corresponding to the operation object 112A, which has “5” as the ID, are displayed in boldface.

### Second Display Example

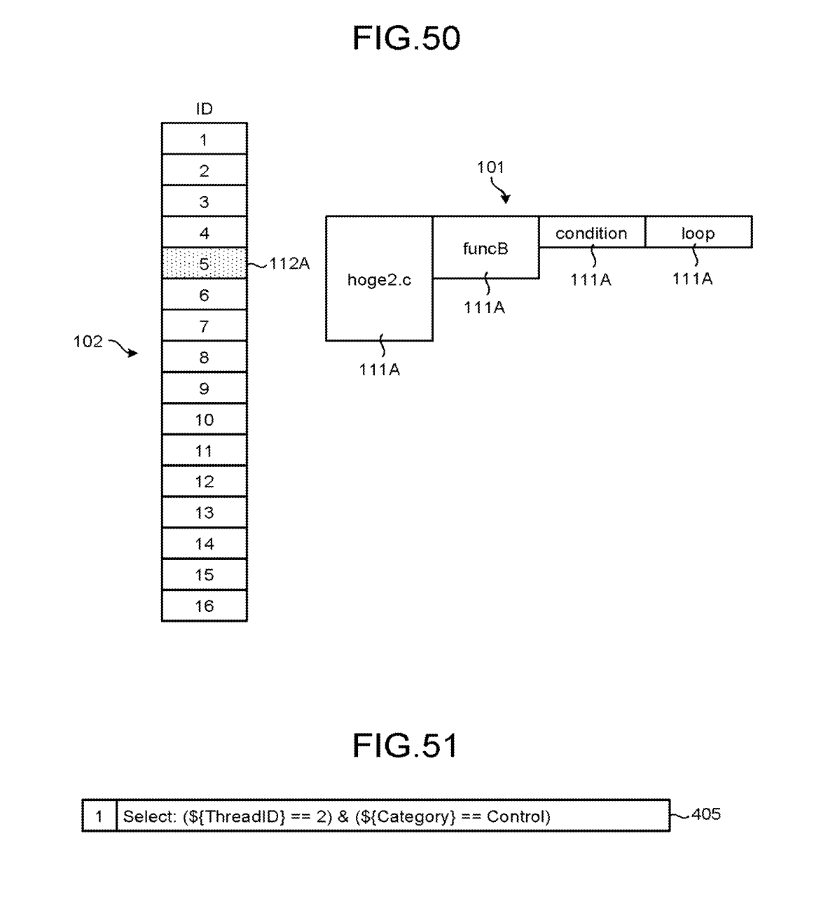

FIG. 49 is a diagram illustrating first display method information 404 in a second display example. FIG. 50 is a diagram illustrating the first display image 101 and the second display image 102 in the second display example. In this example, the first display method information 404 is set in such a way that the section object 111A of the section corresponding to the selected operation is displayed upon being clipped from the entire first display image 101. In the first display image 101 illustrated in FIG. 50, only the section object 111A is displayed that corresponds to the operation object 112A having “5” as the ID.

### Third Display Example

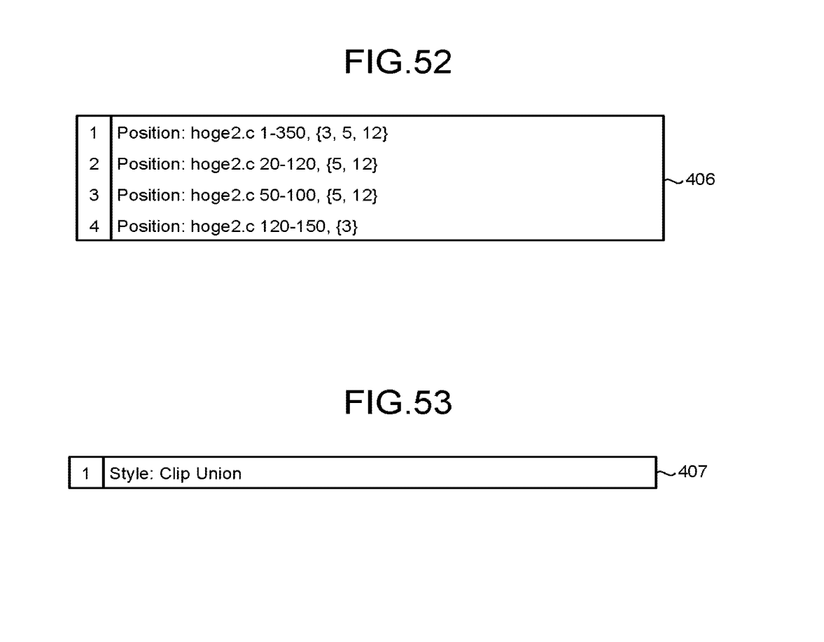

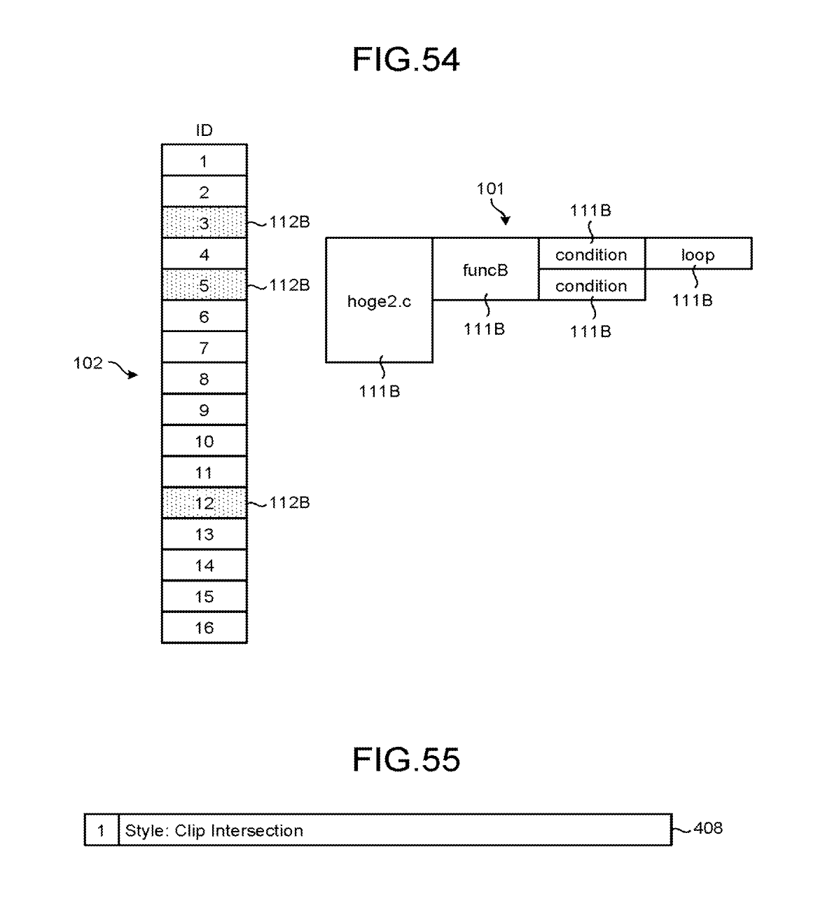

FIG. 51 is a diagram illustrating selection information 405 in a third display example. FIG. 52 is a diagram illustrating section identification information 406 in the third display example. FIG. 53 is a diagram illustrating first display method information 407 in the third display example. FIG. 54 is a diagram illustrating the first display image 101 and the second display image 102 in the third display example.

In this example, the selection information 405 indicates that the operation information 63, the operation information 65, and the operation information 72 having “2” as “ThreadID” and having “Control” as “Category” are to be selected. In this example, the first display method information 407 is set in such a way that the section related to one of the selected operations is clipped and displayed. In the second display image 102 illustrated in FIG. 54, operation objects 112B corresponding to three selected operations (having “3”, “5”, and “12” as the respective IDs) have a different display method than the other operation objects 112. Moreover, in the first display image 101 illustrated in FIG. 54, section objects 111B corresponding to any one of the operation objects 112B are clipped and displayed.

### Fourth Display Example

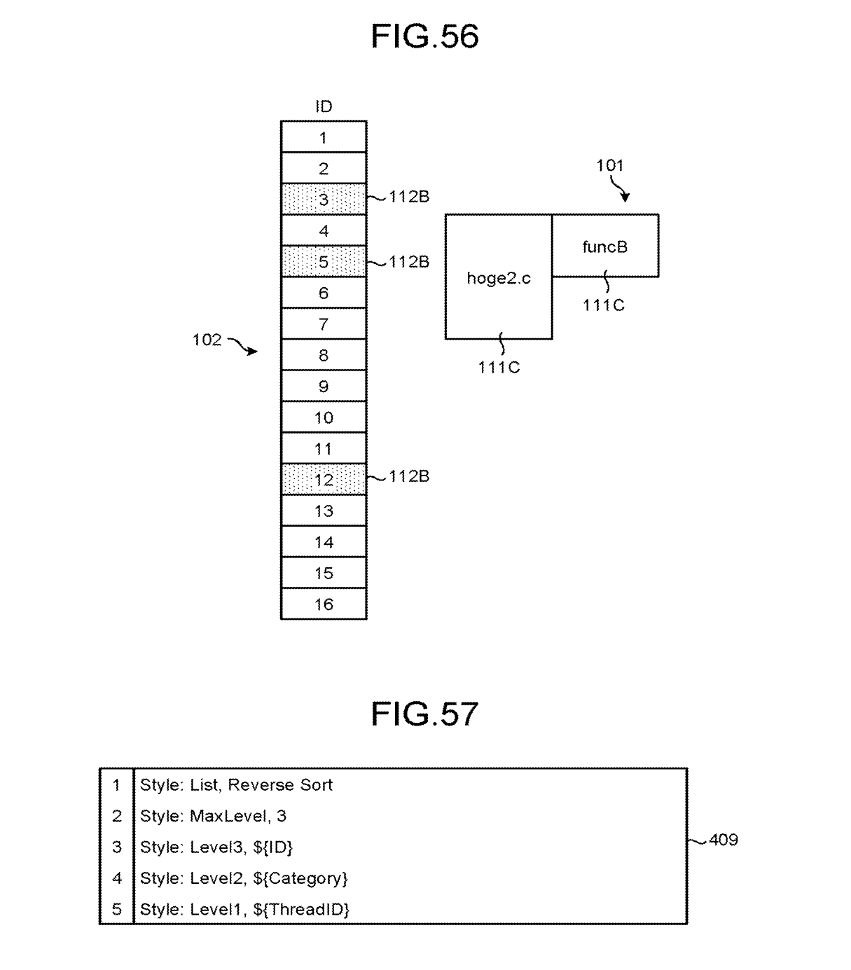

FIG. 55 is a diagram illustrating first display method information 408 in a fourth display example. FIG. 56 is a diagram illustrating the first display image 101 and the second display image 102 in the fourth display example. In this example, the first display method information 408 is set in such a way that the sections related to all selected operations are clipped and displayed. In the first display image 101 illustrated in FIG. 56, section objects 111C corresponding to the sections related to all of the operation objects 112B, which correspond to the three selected operations (having “3”, “5”, and “12” as the respective IDs), are clipped and displayed.

### Fifth Display Example

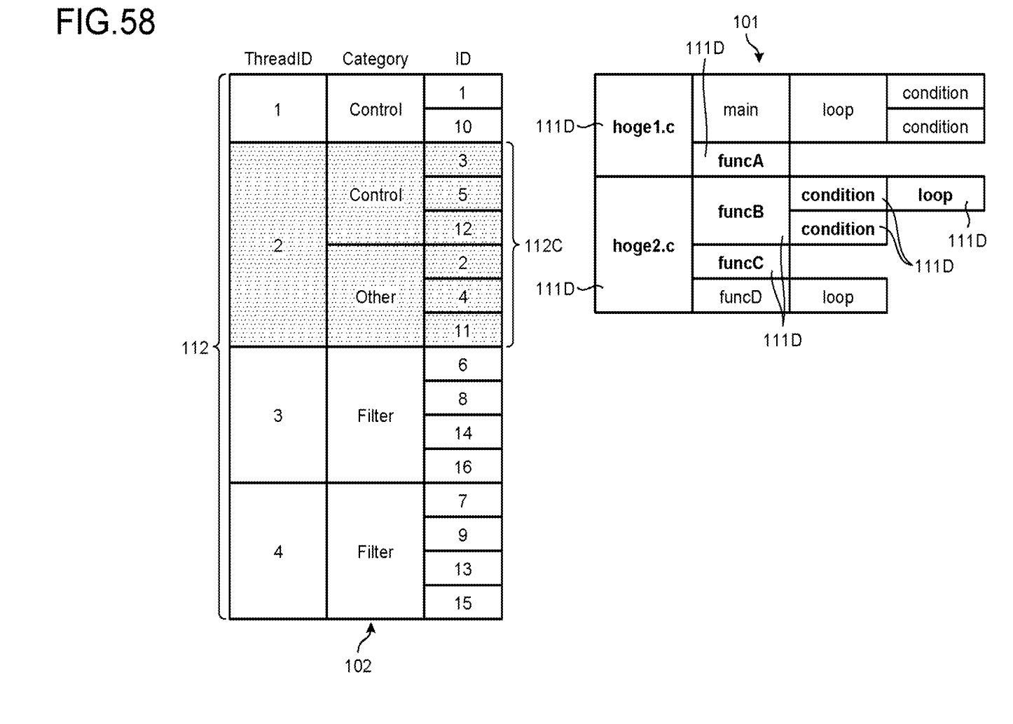

FIG. 57 is a diagram illustrating second display method information 409 in a fifth display example. FIG. 58 is a diagram illustrating the first display image 101 and the second display image 102 in the fifth display example. In this example, the second display method information 409 is set in such a way that the structure of the operations is hierarchized based on “ThreadID”, “Category”, and “ID”. Each operation object 112 is arranged in such a way that “ThreadID” has the hierarchy level 3, “Category” has the hierarchy level 2, and “ID” has the lowest hierarchy level; and in such a way that each of “ThreadID”, “Category”, and “ID” is in ascending order. Moreover, operation objects 112C corresponding to the selected operation are displayed according to a different display method than the other operation objects 112. Furthermore, section objects 111D corresponding to the sections that correspond to the operation objects 112C are displayed according to a different display method than the other section objects 111.

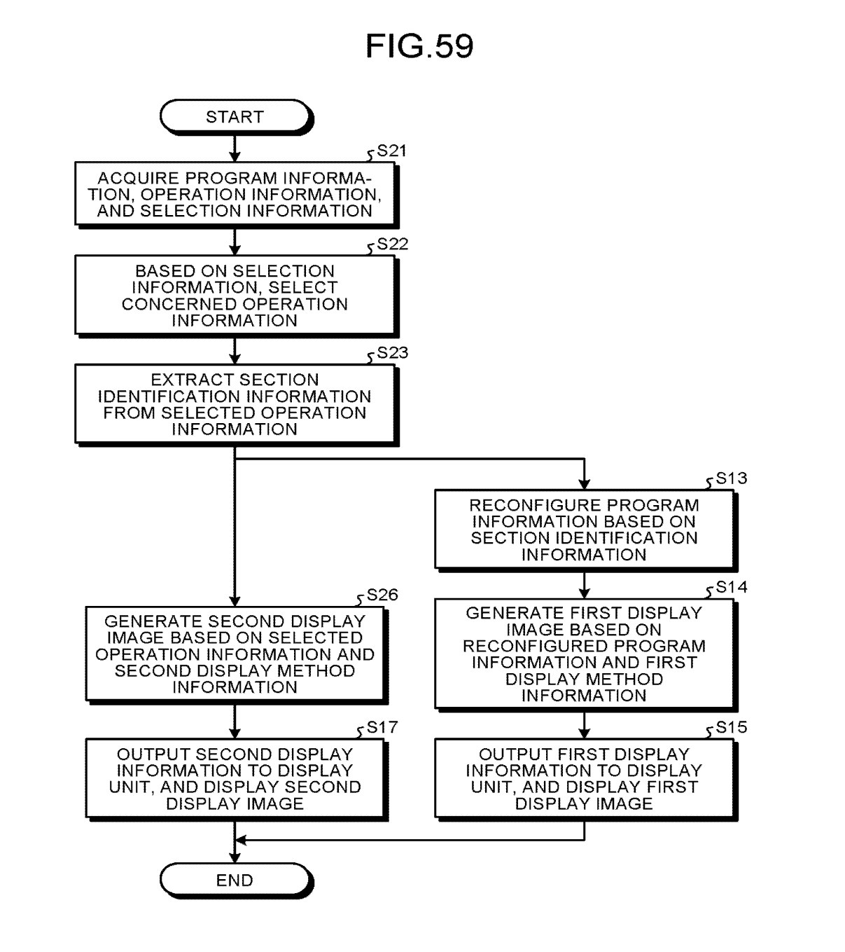

FIG. 59 is a flowchart for explaining a flow of operations performed to display the first display image 101 and the second display image 102 according to the second embodiment. The first acquisition unit 121 acquires the program information; the second acquisition unit 122 acquires the operation information 61 to the operation information 76; and the third acquisition unit 142 acquires the selection information 401 and the selection information 405 (S21).

Based on the selection information 401 and the selection information 405, the selecting unit 143 selects the operation information 61 to the operation information 76 corresponding to the selected operation (S22). The extracting unit 131 extracts the section identification information from the operation information 61 to the operation information 76 selected by the selecting unit 143 (S23). Based on the operation information 61 to the operation information 76 selected by the selecting unit 143 and based on the second display method information 409, the second generating unit 126 generates the second display information (S26). The other steps are identical to the steps described in the first embodiment.

### Third Embodiment

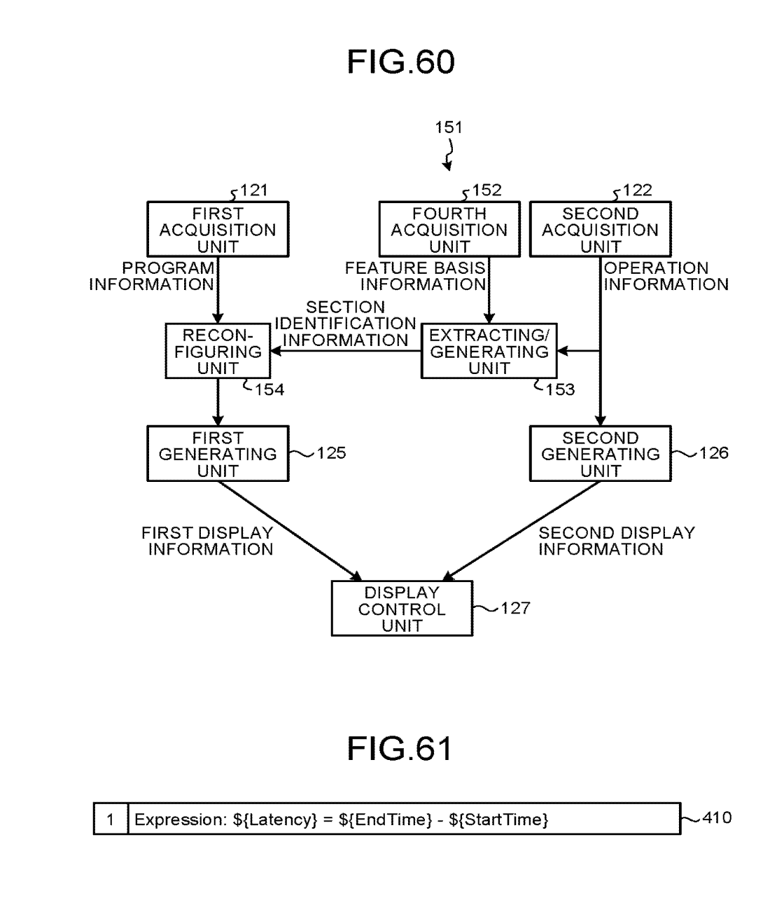

FIG. 60 is a diagram illustrating a functional configuration of a program information generating system 151 according to a third embodiment. As compared to the program information generating system 115 illustrated in the specific example in FIG. 42 according to the first embodiment, the program information generating system 151 according to the third embodiment differs in the way that a fourth acquisition unit 152 and an extracting/generating unit 153 are additionally included and in the way that a reconfiguring unit 154 reconfigures the program information based on the section identification information and feature quantity information (described later).

The fourth acquisition unit 152 acquires feature basis information, which forms the basis for generating the feature quantity information and which is acquired, for example, by executing a computer program. Herein, the feature basis information is related to, for example, the execution period of the operations. More particularly, the feature basis information represents the execution period of each operation or the average execution period of the operations. Such feature basis information can be acquired based on “Parameter: StartTime” and “Parameter: EndTime” specified in the operation information 61 to the operation information 76. However, the method of acquiring the feature basis information is not limited to this method. Alternatively, for example, the feature basis information can be acquired via manual input of the user or can be read from a predetermined memory device.

The extracting/generating unit 153 extracts the section identification information from the operation information 61 to the operation information 76, as well as generates feature quantity information based on the feature basis information. The feature quantity information indicates the execution status of a computer program and represents, for example, the latency. For example, based on the difference between a planned execution period and the actually-measured execution period for a particular operation, it is possible to detect the latency regarding that particular operation or an equivalent operation. Meanwhile, the section identification information and the feature quantity information generated by the extracting/generating unit 153 is output to the reconfiguring unit 154.

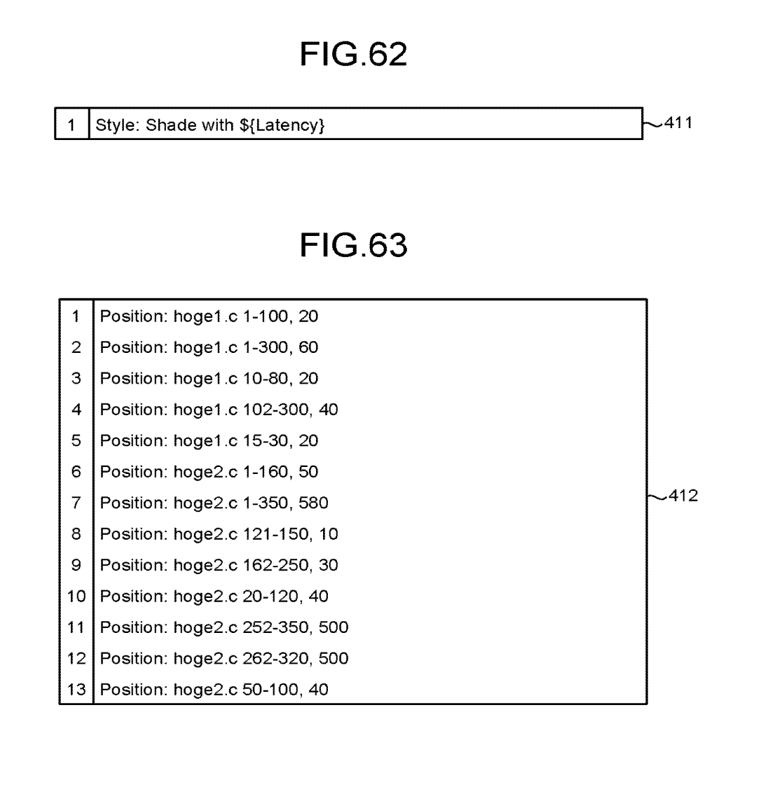

FIG. 61 is a diagram illustrating an equation 410 for generating the feature quantity information. In this example, the difference between “EndTime” and “StartTime” represents the latency and is treated as the feature quantity information. FIG. 62 is a diagram illustrating first display method information 411 according to the third embodiment. In this example, the first display method information 411 represents varying the color tone of the section objects 111 according to the latency value.

FIG. 63 is a diagram illustrating section identification information 412 containing the feature quantity information. For example, in FIG. 63, the section represented by “hoge1.c 1-300” at the second line is indicated to have the latency equal to “60”.

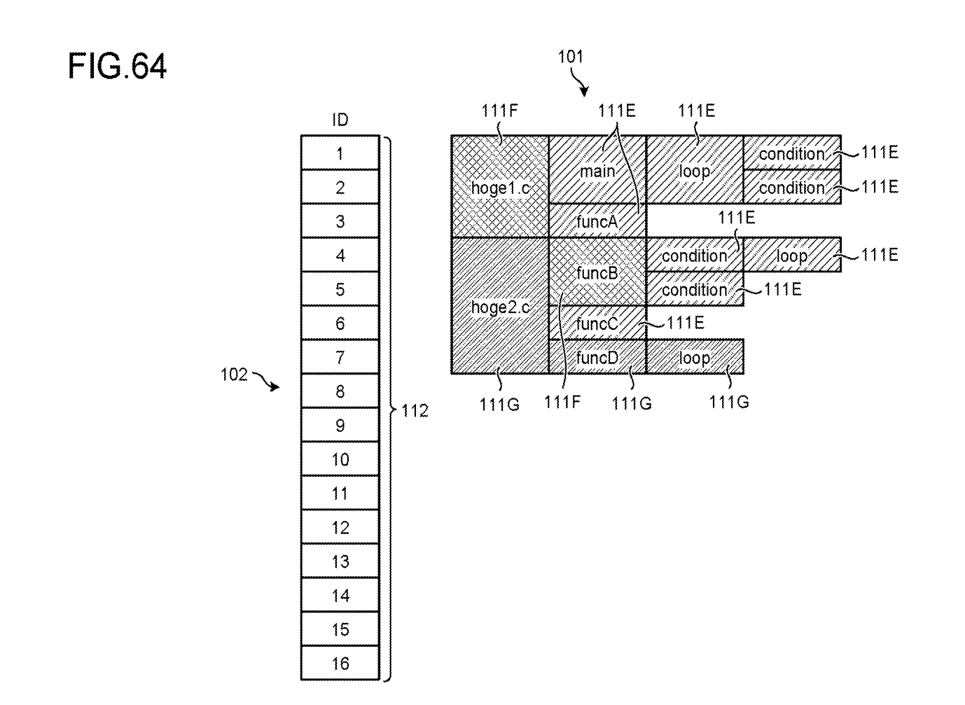

FIG. 64 is a diagram illustrating the first display image 101 and the second display image 102 according to the third embodiment. In this example, the first display image 101 includes section objects 111E having a first color tone, section objects 111F having a second color tone, and section objects 111G having a third color tone. Such differences in the color tone are determined according to the latency value.

In this example, the section objects 111G, which correspond to three sections, namely, “hoge2.c 1-350, 580”, “hoge2.c 252-350, 500”, and “hoge2.c 260-320, 500” having a relatively high latency, are assigned with the third color tone that is the darkest.

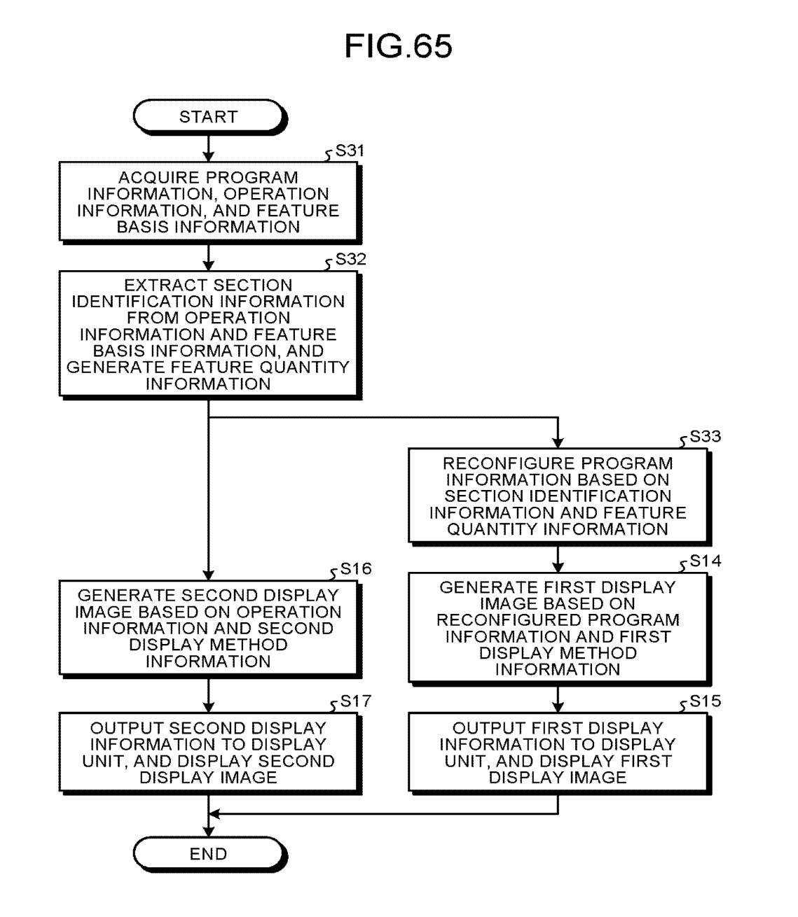

FIG. 65 is a flowchart for explaining a flow of operations performed to display the first display image 101 and the second display image 102 according to the third embodiment. The first acquisition unit 121 acquires the program information; the second acquisition unit 122 acquires the operation information 61 to the operation information 76; and the fourth acquisition unit 152 acquires the feature basis information (S31). The extracting/generating unit 153 extracts the section identification information based on the operation information 61 to the operation information 76, as well as generates feature quantity information based on the feature basis information (S32). Based on the section identification information and the feature quantity information, the reconfiguring unit 154 reconfigures the program information (S33). The other steps are identical to the steps described in the flowchart illustrated in FIG. 42.

### Fourth Embodiment

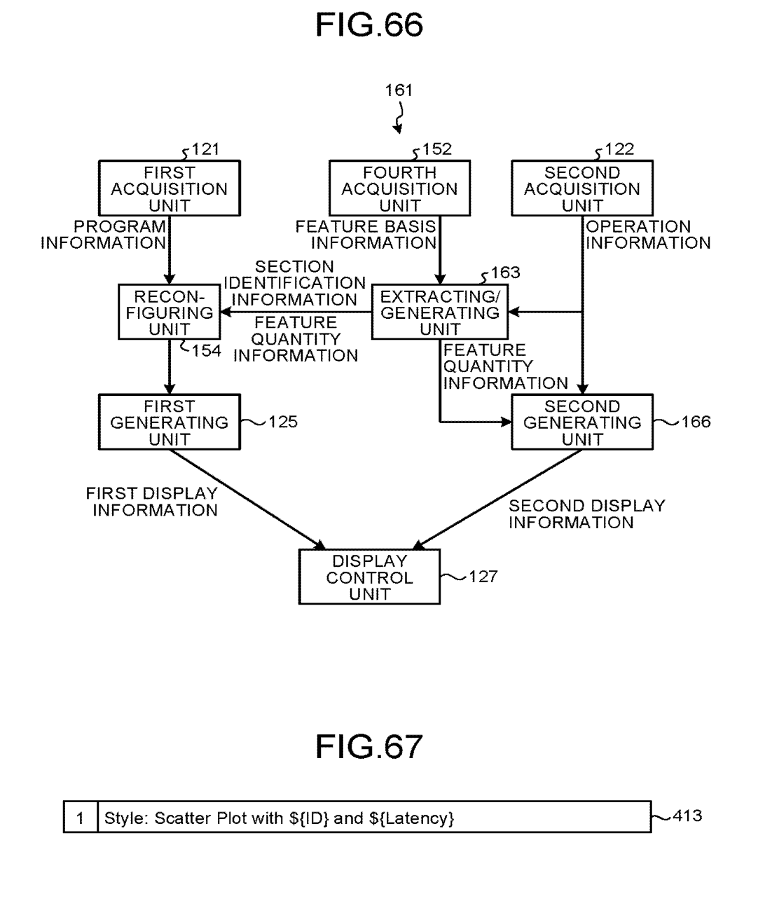

FIG. 66 is a diagram illustrating a functional configuration of a program information generating system 161 according to a fourth embodiment. As compared to the program information generating system 151 illustrated in FIG. 60 according to the third embodiment, the program information generating system 161 according to the fourth embodiment differs in the way that an extracting/generating unit 163 outputs the feature quantity information to a second generating unit 166, which then generates the second display information based on the operation information 61 to the operation information 76 and based on the second display method information.

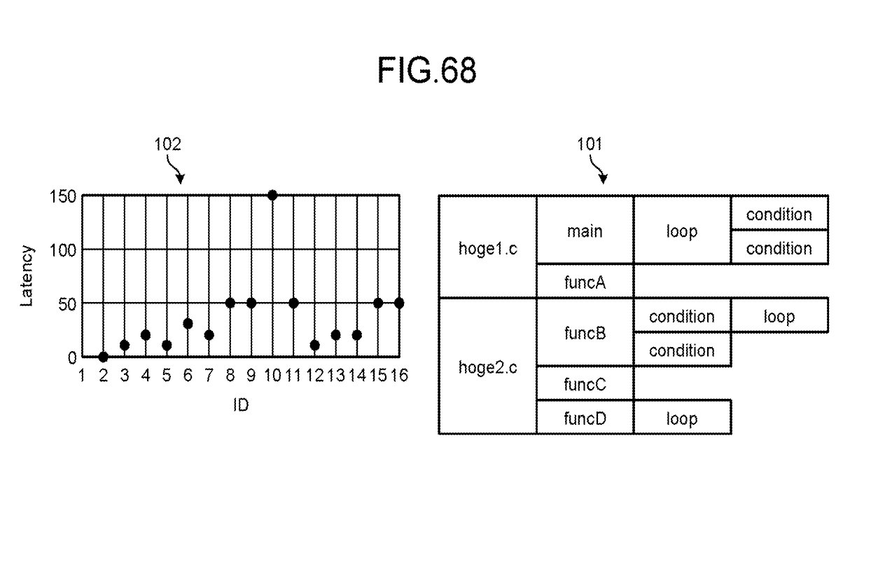

FIG. 67 is a diagram illustrating second display method information 413 in a first display example according to the fourth embodiment. In this example, the second display method information 413 indicates that the second display image 102 is to be displayed as a point diagram in which the horizontal axis represents the ID and the vertical axis represents the latency. FIG. 68 is a diagram illustrating the first display image 101 and the second display image 102 in the first display example according to the fourth embodiment. In this example, in the second display image 102, for example, it is visually expressed that the operation having “10” as the ID has the latency equal to “150”, which is prominently greater than the operations having the other IDs.

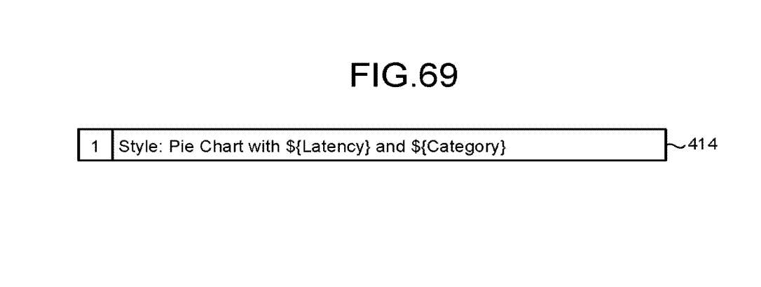

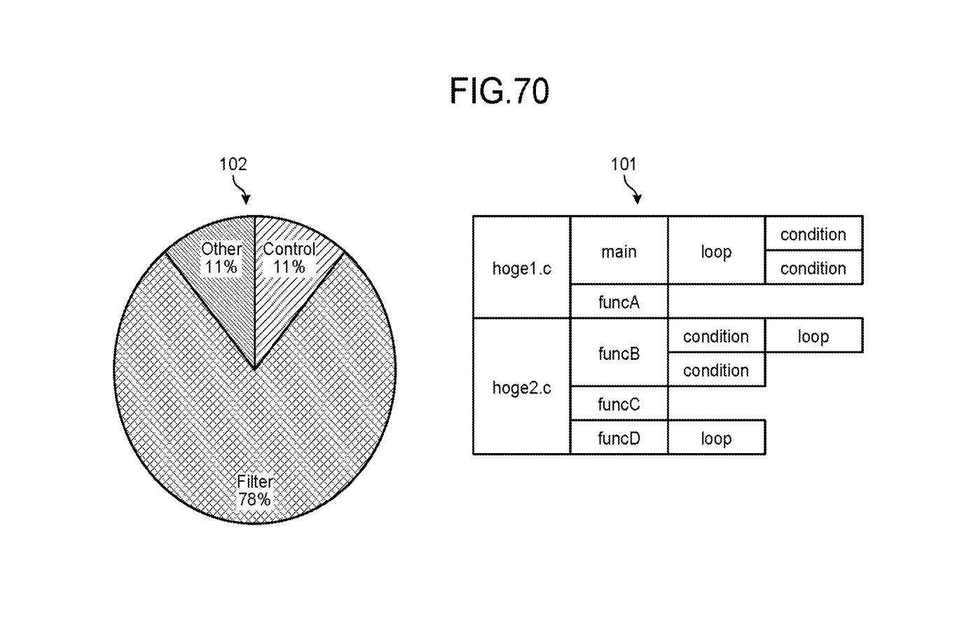

FIG. 69 is a diagram illustrating second display method information 414 in a second display example according to the fourth embodiment. In this example, the second display method information 414 indicates that the second display image 102 is displayed as a pie chart in which the latency is tallied on a category-by-category basis. FIG. 70 is a diagram illustrating the first display image 101 and the second display image 102 in the second display example according to the fourth embodiment. In this example, in the second display image 102 is displayed the percentage of category-wise latency against the overall latency. In this example, the operations belonging to “Control” have the latency equal to 11%; the operations belonging to “Filter” have the latency equal to 78%; and the operations belonging to the other categories have the latency equal to 11%. From such a pie chart, for example, it is possible to infer that the delay in the computer program is mainly attributed to the operations belonging to “Filter”.

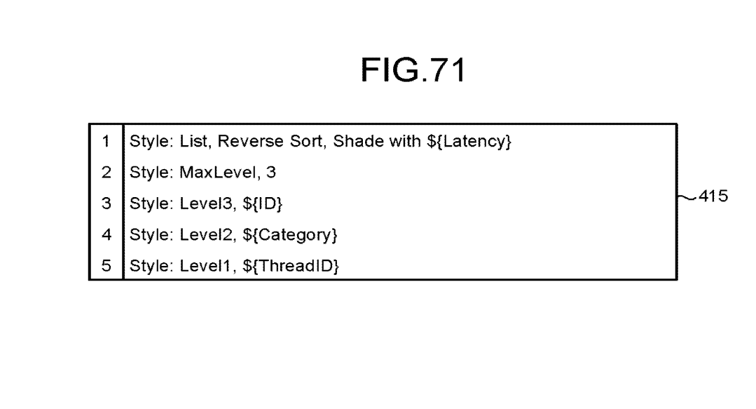

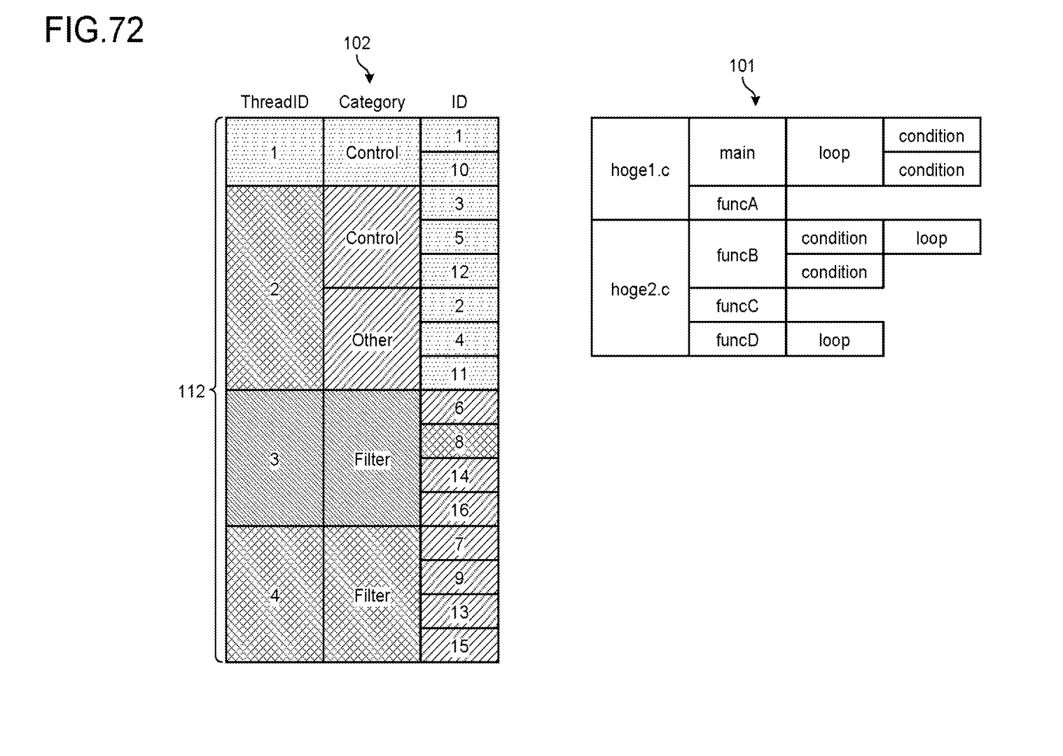

FIG. 71 is a diagram illustrating second display method information 415 in a third display example according to the fourth embodiment. FIG. 72 is a diagram illustrating the first display image 101 and the second display image 102 in the third example according to the fourth embodiment. In this example, in an identical manner to the second display method information 409 in the fifth display example illustrated in FIG. 57 according to the second embodiment, the second display method information 415 is set in such a way that the structure of the operations is displayed upon hierarchization based on “ThreadID”, “Category”, and “ID”, as well as the color tone of the operation objects 112 is varied according to the latency. In this example, the display method of the operation objects 112 is set in such a way that, greater the latency, the darker becomes the color tone.

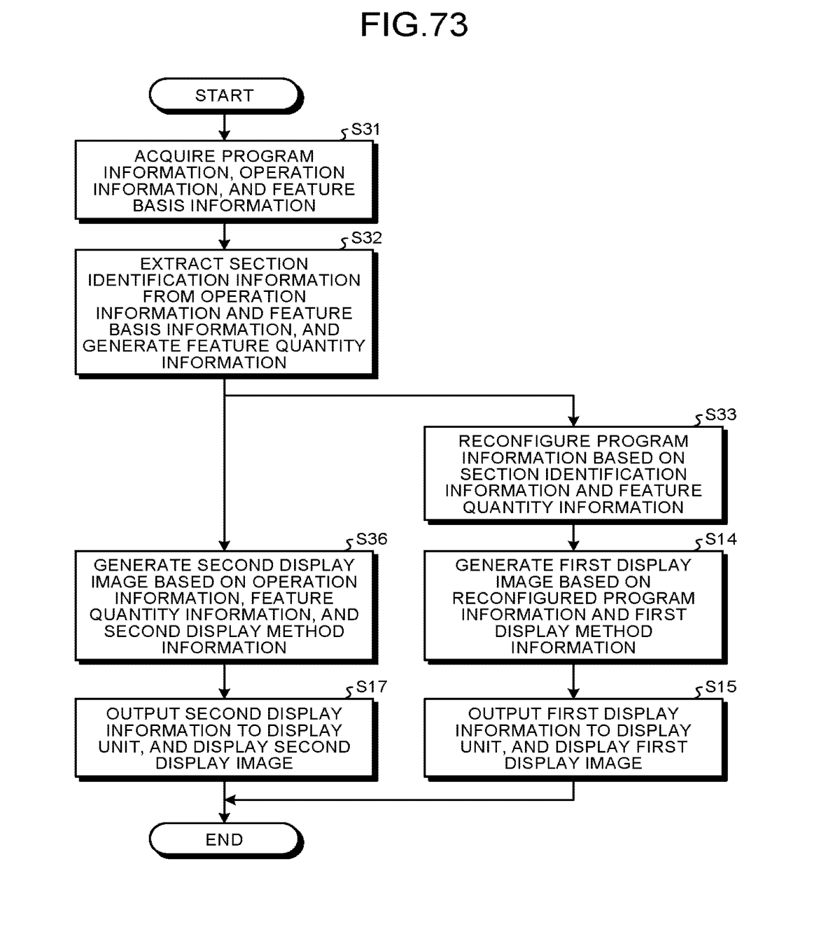

FIG. 73 is a flowchart for explaining a flow of operations performed to display the first display image 101 and the second display image 102 according to the fourth embodiment. The second generating unit 166 generates second display information based on the operation information 61 to the operation information 76, based on the feature quantity information, and based on the second display method information 413 to the second display method information 415 (S36). The other steps are identical to the steps described in the flowchart illustrated in FIG. 65 according to the third embodiment.

### Fifth Embodiment

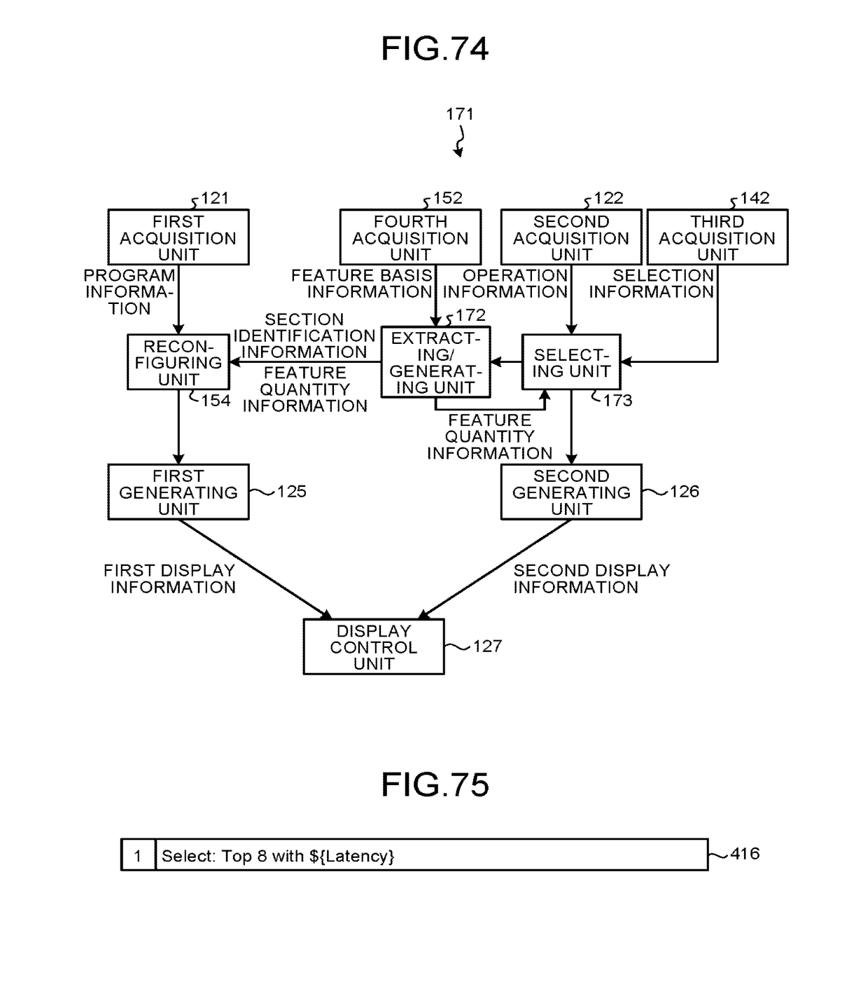

FIG. 74 is a diagram illustrating a functional configuration of a program information generating system 171 according to a fifth embodiment. As compared to the program information generating system 161 illustrated in FIG. 66 according to the fourth embodiment, the program information generating system 171 according to the fifth embodiment differs in the way that the third acquisition unit 142 and a selecting unit 173 are additionally included. In an identical manner to the third acquisition unit 142 according to the second embodiment, the third acquisition unit 142 acquires selection information that enables identification of the selected operation from among one or more operations.

An extracting/generating unit 172 according to the fifth embodiment outputs the generated feature information to the selecting unit 173 in an identical manner to the third and fourth embodiments. Based on the operation information 61 to the operation information 76, based on the selection information, and based on the feature quantity information; the selecting unit 173 selects the operation information 61 to the operation information 76 to be output to the second generating unit 126.

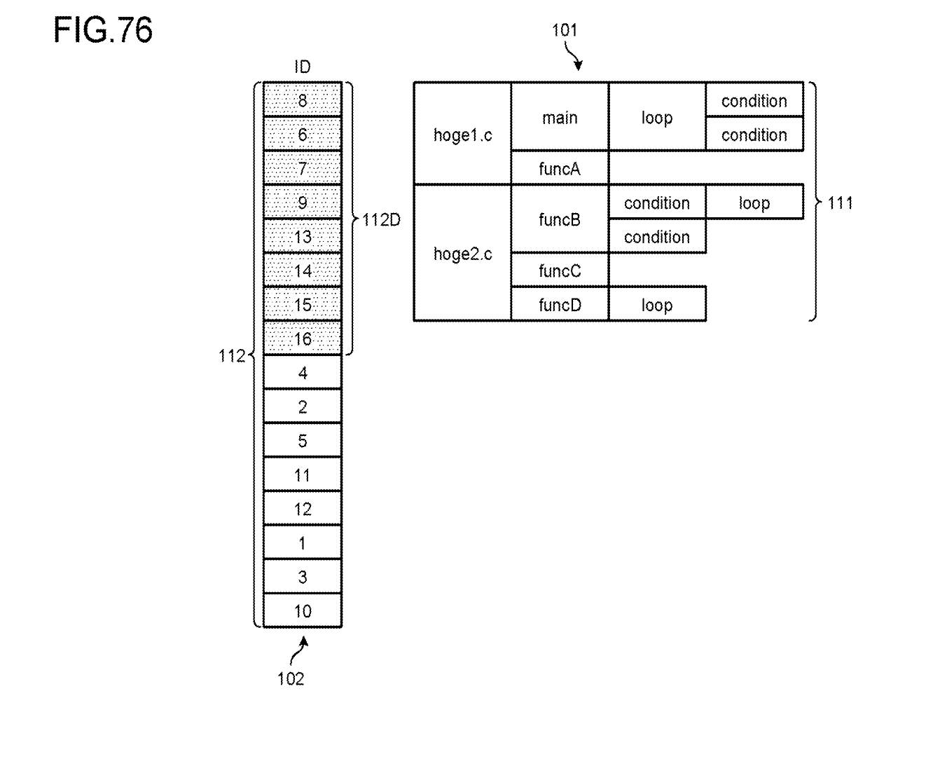

FIG. 75 is a diagram illustrating second display method information 416 according to the fifth embodiment. FIG. 76 is a diagram illustrating the first display image 101 and the second display image 102 according to the fifth embodiment. In this example, the second display method information 416 indicates that eight operations are selected in descending order of latencies. In this example, in the second display image 102 is illustrated a state in which the operation objects 112 are sorted in descending order of latencies and top eight operation objects 112D are displayed according to a different display method than the other operation objects 112. That enables easy identification of the operations having a high latency.

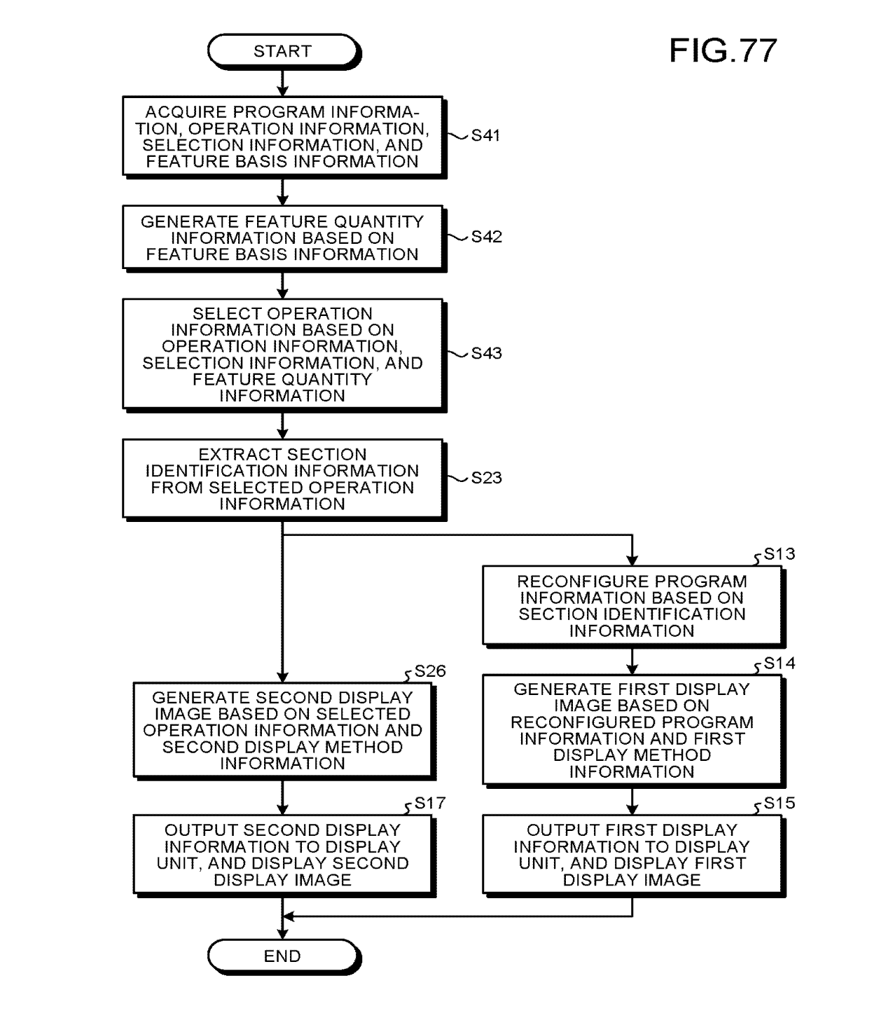

FIG. 77 is a flowchart for explaining a flow of operations performed to display the first display image 101 and the second display image 102 according to the fifth embodiment. The first acquisition unit 121 acquires the program information; the second acquisition unit 122 acquires the operation information 61 to the operation information 76; the third acquisition unit 142 acquires the selection information; and the fourth acquisition unit 152 acquires the feature basis information (S41). The extracting/generating unit 172 generates feature quantity information based on the feature basis information (S42). The selecting unit 173 selects operation information based on the operation information 61 to the operation information 76, based on the selection information, and based on the feature quantity information (S43). The second generating unit 126 generates second display information based on the operation information 61 and the operation information 76 selected at Step S43 by taking into account the feature quantity information and based on the second display method information 416 (S26). The other steps are identical to the flowchart illustrated in FIG. 59 according to the second embodiment.

The control program that implements the functions of the program information generating system can be recorded as an installable or executable file in a computer-readable recording medium such as a CD-ROM, a flexible disk (FD), a compact disk readable (CD-R), and a digital versatile disk (DVD). Alternatively, the control program can be downloaded from a predetermined memory device, which is connected to a network, into a predetermined information processing device. Still alternatively, the control program can be stored in advance in a predetermined ROM of a predetermined information processing device. Meanwhile, the control program can be configured with a plurality of modules for implementing the functions of the constituent elements mentioned above.

The functions of the constituent elements can be implemented by making the CPU 5 execute the control program, or can be implemented using hardware such as an integrated circuit (IC), can be implemented using a combination of software and hardware.

In the program information generating system according to the embodiments described above, the first display image 101 indicating the structure of the computer program and the second display image 102 indicating the structure of the operations are displayed side-by-side. As a result, the execution status of the computer program can be understood in an accurate way. Moreover, since the correspondence relationship between the sections and the operations within a computer program are displayed in such a suitable display format that the correspondence relationship is identifiable, the execution status of the computer program can be understood in an accurate way even if the number of sections and the number of operations is large. Furthermore, the display format is changed not only based on the correspondence relationship between the sections and the operations but also based on predetermined feature quantity information (such as latency). Hence, understanding of the execution status of the computer program, such as problem finding, becomes possible in a more accurate way.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A program information generating system comprising:
an acquisition unit that acquires program information which represents structure of a computer program and operation information which represents structure of operations generated as a result of execution of the computer program;
a generating unit that generates first display information for generating a first display image which visually represents the structure of the computer program on the basis of the program information and second display information for generating a second display image which visually represents the structure of the operations on the basis of the operation information; and
a display control unit that controls a display unit so that the first display image is displayed on the basis of the first display information and the second display image is displayed on the basis of the second display information, wherein
the program information includes section information which identifies a position of each of sections included in the computer program,
the operation information includes section identification information which identifies the section corresponding to each of the operations, and
the generating unit generates the first display information and the second display information on the basis of the section information and the section identification information so that correspondence relationship between the sections and the operations becomes identifiable.

2. The program information generating system according to claim 1, wherein
the acquisition unit further acquires selection information which identifies a selected operation selected from the operations, and
the generating unit generates the first display information and the second display information so that the correspondence relationship between the selected operation and the section becomes identifiable.

3. The program information generating system according to claim 1, further comprising:
an extracting unit that extracts the section identification information from the operation information; and
a reconfiguring unit that reconfigures the program information so that the section corresponding to the operation identified by the extracted section identification information become identifiable.

4. The program information generating system according to claim 1, wherein, the generating unit generates at least one of the first display information or the second display information on the basis of feature quantity information which indicates execution status of the computer program so that the operation in a predetermined state is identifiable or the section corresponding to the operation in the predetermined state are identifiable.

5. The program information generating system according to claim 4, wherein the feature quantity information represents latency which is detected on the basis of execution period of the computer program.

6. The program information generating system according to claim 1, wherein
the first display image includes a section object corresponding to the section,
the second display image includes an operation object corresponding to the operation, and
the generating unit generates the first display information or the second display information so that the section object made identifiable is displayed according to a different display method than other of the section object or the operation object made identifiable is displayed according to a different display method than other of the operation object.

7. The program information generating system according to claim 1, further comprising:
an information processing terminal that is used by a user, and
a server that is connected to the information processing terminal via a network, wherein
the server performs at least some part of operation for generating at least one of the first display information or the second display information, and
the display unit of the information processing terminal displays the first display image and the second display image.

8. A program information generating method for generating information indicating execution status of a computer program by programmed processing of a computer, the program information generating method comprising:
acquiring program information which represents structure of a computer program;
acquiring operation information which represents structure of operations generated as a result of execution of the computer program;
generating first display information for generating a first display image which visually represents the structure of the computer program on the basis of the program information;
generating second display information for generating a second display image which visually represents the structure of the operations on the basis of the operation information;
controlling a display unit so that the first display image is displayed on the basis of the first display information and the second display image is displayed on the basis of the second display information, wherein
the program information includes section information which identifies a position of each of sections included in the computer program,
the operation information includes section identification information which identifies the section corresponding to each of the operations, and
the first display information and the second display information are generated on the basis of the section information and the section identification information so that correspondence relationship between the sections and the operations becomes identifiable.

9. A computer program product having a non-transitory computer readable medium including a program information generating program, wherein the program information generating program, when executed by a computer, causes the computer to execute:
acquiring program information which represents structure of a computer program;
acquiring operation information which represents structure of operations generated as a result of execution of the computer program;
generating first display information for generating a first display image which visually represents the structure of the computer program on the basis of the program information;
generating second display information for generating a second display image which visually represents the structure of the operations on the basis of the operation information;
controlling a display unit so that the first display image is displayed on the basis of the first display information and the second display image is displayed on the basis of the second display information, wherein
the program information includes section information which identifies a position of each of sections included in the computer program,
the operation information includes section identification information which identifies the section corresponding to each of the operations, and
the first display information and the second display information are generated on the basis of the section information and the section identification information so that correspondence relationship between the sections and the operations becomes identifiable.
